(19) United States
(12) Patent Application Publication
(10) Pub. No.: US 2026/0339163 A1
(43) Pub. Date: Oct. 29, 2026

(54) LENS DRIVING DEVICE, CAMERA DEVICE, AND OPTICAL DEVICE

(71) Applicant: LG INNOTEK CO., LTD., Seoul (KR)

(72) Inventors: Yun Ho NOH, Seoul (KR); Sung Guk LEE, Seoul (KR)

(21) Appl. No.: 19/116,219

(22) PCT Filed: Jun. 26, 2023
(86) PCT No.: PCT/KR2023/008873

§ 371 Date: Mar. 27, 2025

(30) Foreign Application Priority Data
Sep. 27, 2022 (KR) 10-2022-0122772

(51) Int. Cl. G03B 5/04; G03B 13/36

(52) U.S. Cl. CPC G03B 5/04; G03B 13/36

(57) ABSTRACT

The present embodiment relates to a lens driving device comprising: a base; a housing arranged on the base; a guide frame arranged in the housing; a bobbin arranged in the guide frame; a first ball arranged between the base and the housing; a second ball arranged between one side surface of the guide frame and the side surface of the housing; and a third ball arranged between the side surface of the bobbin and the other side surface of the guide frame.

### TECHNICAL FIELD

The present embodiment relates to a lens driving device, a camera device, and an optical device.

### BACKGROUND ART

A camera device is a device that photographs a picture or video of a subject, and is installed in optical instruments such as smartphones, drones, and vehicles.

An auto-focus function that automatically adjusts the focus according to the distance of the subject is applied to the camera device. In addition, a handshake correction function is applied to prevent a phenomenon in which the focus is shaken by the user's handshake.

Autofocus and handshake correction functions can be performed through the electromagnetic interaction between the magnet and the coil.

However, in conventional lens driving devices, in the disposement of magnets and coils for performing the autofocus function, magnets that do not require electrical connection are disposed in the moving part, and the coils are disposed in the fixed part. In this case, there is a problem that the magnets, which are heavier than the coils, are disposed in the moving part, and the current consumption for performing the autofocus function increases.

In particular, recently, as image sensors become highly pixelated, the lens diameter has increased, and the weight of the lens has also increased, which has exacerbated the problem.

In addition, in order to dispose the magnets and coils, and the like for performing the auto focus function and handshake correction function, a size larger than the thickness of the smartphone in an optical axis direction is required, which causes the camera device mounted on the smartphone to be protruded more than other portions of the smartphone.
(Patent Literature 1) KR 10-2015-0118005 A

### DETAILED DESCRIPTION OF THE INVENTION

### Technical Subject

The present embodiment is intended to provide a lens driving device in which power consumption for performing an autofocus function is reduced by disposing a coil that is lightweight compared to a magnet in a moving unit.

In addition, the present embodiment is intended to provide a camera device having an autofocus function and a handshake correction function, but with a minimized size in an optical axis direction.

### Technical Solution

A lens driving device according to the present embodiment may comprise: a base; a housing being disposed on the base; a guide frame being disposed inside the housing; a bobbin being disposed in the guide frame; a first ball being disposed between the base and the housing; a second ball being disposed between one side surface of the guide frame and the side surface of the housing; and a third ball being disposed between the side surface of the bobbin and the other side surface of the guide frame.

A lens driving device according to the present embodiment may comprise: a fixed unit; a first moving unit being disposed on the fixed unit; a second moving unit being disposed inside the first moving unit and comprising a bobbin and a guide frame; a first drive unit moving the first moving unit in an optical axis direction; a second drive unit moving the second moving unit in a direction perpendicular to the optical axis direction; a first support member being disposed between the first moving unit and the fixed unit; a second support member being disposed between side surfaces of the first moving unit and the second moving unit; and a third support member being disposed between a side surface of the bobbin and a side surface of the guide frame.

The lens driving device may comprise a first driving unit that moves the guide frame in a first direction perpendicular to the optical axis direction; and a second driving unit that moves the bobbin in a second direction perpendicular to the optical axis direction and the first direction.

A lens driving device according to the present embodiment may comprise: a fixed unit; a first moving unit being disposed on the fixed unit; a second moving unit being disposed inside the first moving unit and comprising a bobbin and a guide frame; a first drive unit moving the first moving unit in an optical axis direction; a second drive unit being disposed in the first moving unit and the second moving unit and moving the second moving unit in an x-axis; and a third drive unit moving the bobbin in a y-axis.

The first moving unit may bring the bobbin in close contact with the guide frame.

The first moving unit may comprise a yoke that brings the bobbin in close contact with the guide frame.

The first moving unit may comprise a first yoke that brings the first moving unit in close contact with the fixed unit and a second yoke that brings the guide frame in close contact with the first moving unit.

The first moving unit may comprise a third yoke that brings the bobbin in close contact with the guide frame.

The first moving unit may comprise a housing, and the first to third yokes may be coupled to the housing.

The third drive unit may comprise a first magnet being disposed in the bobbin and a first coil interacting with the first magnet, and the first coil may move together with the first moving unit.

The second drive unit may comprise a second magnet being disposed in the guide frame and a second coil interacting with the second magnet, and the second coil may move together with the first moving unit.

The first drive unit may comprise a third magnet being disposed in the fixed unit and a third coil interacting with the third magnet, and the third coil may move together with the first moving unit.

The lens driving device may comprise a fourth magnet being disposed in the bobbin and a yoke being disposed in the second moving unit so as to exert an attractive force on the fourth magnet.

When the second moving unit moves along the x-axis by the second drive unit, the distance between the fourth magnet and the yoke along the x-axis is maintained, and the distance between the first magnet and the first coil along the x-axis can be changed.

The fourth magnet may be spaced apart from the first magnet, and the fourth magnet may not face the first coil.

Each of the first magnet, the second magnet, and the fourth magnet may comprise a first magnet portion comprising an N pole and a S pole, a second magnet portion comprising a S pole and a N pole, and a neutral portion being disposed between the first magnet portion and the second magnet portion.

When viewed from above, the third magnet, the third coil, the first magnet, and the first coil can be disposed in sequence on a first imaginary straight line parallel to the x-axis.

When viewed from above, the third magnet, the third coil, the fourth magnet, and the yoke can be disposed in sequence on a second imaginary straight line parallel to the x-axis.

A camera device according to the present embodiment may comprise: a printed circuit board; an image sensor being disposed in the printed circuit board; a lens driving device being disposed in the printed circuit board; and a lens being coupled to the lens driving device.

An optical device according to the present embodiment may comprise: a main body; a camera device being disposed in the main body; and a display being disposed in the main body and outputting at least one of an image and a video photographed by the camera device.

### Advantageous Effects

Through the present embodiment, as the coil having a lighter weight than the magnet is disposed in the moving unit, current consumption for performing the auto-focus function may be reduced.

In addition, it is possible to perform an auto-focus function and a handshake correction function in a camera device of a size being minimized in an optical axis direction.

That is, according to the present embodiment, even though it is a camera device not being protruded from a smartphone, both an auto-focus function and a handshake correction function can be performed.

### BRIEF DESCRIPTION OF DRAWINGS

FIG. 1 is a conceptual diagram of a lens driving device according to the present embodiment.

FIG. 2 is a perspective view of a lens driving device according to the present embodiment.

FIG. 3 is a cross-sectional view taken along line A-A of FIG. 2.

FIG. 4 is a cross-sectional view taken along line B-B of FIG. 2.

FIG. 5 is a cross-sectional view taken along line C-C of FIG. 2.

FIG. 6 is a cross-sectional view of a lens driving device according to the present embodiment cut in a direction perpendicular to an optical axis and viewed from above.

FIG. 7 is an exploded perspective view of a lens driving device according to the present embodiment.

FIG. 8 is an exploded perspective view of a lens driving device according to the present embodiment viewed from a different direction than FIG. 7.

FIG. 9 is a perspective view of a lens driving device according to the present embodiment with a cover omitted.

FIG. 10 is a perspective view illustrating a fixed unit and related configuration of a lens driving device according to the present embodiment.

FIG. 11 is a perspective view illustrating a moving unit and related configuration of a lens driving device according to the present embodiment.

FIG. 12 is a perspective view illustrating a moving unit and related configuration of a lens driving device viewed from a different direction from FIG. 11.

FIG. 13 is a bottom perspective view illustrating a moving unit and related configuration of a lens driving device viewed from a different direction from FIG. 11 and FIG. 12.

FIG. 14 is a perspective view illustrating an AF moving unit and related configuration of a lens driving device according to the present embodiment.

FIG. 15 is a perspective view illustrating an AF moving unit and related configuration of a lens driving device viewed from a different direction from FIG. 14.

FIG. 16 is a perspective view illustrating an OIS moving unit and related configuration of a lens driving device according to the present embodiment.

FIG. 17 is a perspective view illustrating an OIS moving unit and related configuration of a lens driving device viewed from a different direction from FIG. 16.

FIG. 18 is a perspective view illustrating an OIS-x moving unit and related configuration of a lens driving device according to the present embodiment.

FIG. 19 is a perspective view illustrating an OIS-x moving unit and related configuration of a lens driving device viewed from a different direction than FIG. 18.

FIG. 20 is a perspective view illustrating an OIS-y moving unit and related configuration of a lens driving device according to the present embodiment.

FIG. 21 is a bottom view illustrating a drive unit and related configuration of a lens driving device according to the present embodiment.

FIG. 22 is a cross-sectional view illustrating an AF guide ball and related configuration of a lens driving device according to the present embodiment.

FIG. 23 is a side view illustrating an AF guide ball and related configuration with the base omitted.

FIG. 24 is a cross-sectional view illustrating an AF guide ball and related configuration with the AF carrier omitted.

FIG. 25 is a perspective view illustrating an AF guide ball and related configuration with the AF carrier omitted.

FIG. 26 is a perspective view illustrating an AF guide ball and related configuration with the AF carrier omitted, viewed from a different direction than FIG. 25.

FIGS. 27 to 29 are diagrams for explaining the auto focus driving of a lens driving device according to the present embodiment. FIG. 27 is a cross-sectional view illustrating the appearance of a moving unit in an initial state where no current is applied to the AF coil. FIG. 28 is a cross-sectional view illustrating the appearance where a moving unit moves upward in an optical axis direction when a forward current is applied to an AF coil. FIG. 29 is a cross-sectional view illustrating the appearance where a moving unit moves downward in an optical axis direction when a reverse current is applied to an AF coil.

FIGS. 30 to 32 are diagrams for explaining the handshake correction driving of a lens driving device according to the present embodiment. FIG. 30 is a cross-sectional view illustrating the appearance of an OIS moving unit in an initial state in which no current is applied to an OIS-x coil and an OIS-y coil. FIG. 31 is a cross-sectional view illustrating the appearance in which an OIS moving unit moves in an x-axis direction perpendicular to the optical axis when current is applied to the OIS-x coil. FIG. 32 is a cross-sectional view illustrating the appearance in which the OIS-y moving unit moves in a y-axis direction perpendicular to both the optical axis and the x-axis when current is applied to an OIS-y coil.

FIG. 33 is an exploded perspective view of a camera device according to the present embodiment.

FIG. 34 is a perspective view of an optical device according to the present embodiment.

FIG. 35 is a perspective view of an optical device according to a modified embodiment.

### BEST MODE

Hereinafter, preferred embodiments of the present invention will be described in detail with reference to the accompanying drawings.

However, the technical idea of the present invention is not limited to some embodiments to be described, but may be implemented in various forms, and inside the scope of the technical idea of the present invention, one or more of the constituent elements may be selectively combined or substituted between embodiments.

In addition, the terms (comprising technical and scientific terms) used in the embodiments of the present invention, unless explicitly defined and described, can be interpreted as a meaning that can be generally understood by a person skilled in the art, and commonly used terms such as terms defined in the dictionary may be interpreted in consideration of the meaning of the context of the related technology.

In addition, terms used in the present specification are for describing embodiments and are not intended to limit the present invention.

In the present specification, the singular form may comprise the plural form unless specifically stated in the phrase, and when described as “at least one (or more than one) of A and B and C”, it may comprise one or more of all combinations that can be combined with A, B, and C.

In addition, in describing the components of the embodiment of the present invention, terms such as first, second, A, B, (a), and (b) may be used. These terms are merely intended to distinguish the components from other components, and the terms do not limit the nature, order or sequence of the components.

And, when a component is described as being ‘connected’, ‘coupled’ or ‘interconnected’ to another component, the component is not only directly connected, coupled or interconnected to the other component, but may also comprise cases of being ‘connected’, ‘coupled’, or ‘interconnected’due that another component between that other components.

In addition, when described as being formed or disposed in “on (above)” or “below (under)” of each component, “on (above)” or “below (under)” means that it comprises not only the case where the two components are directly in contact with, but also the case where one or more other components are formed or disposed between the two components. In addition, when expressed as “on (above)” or “below (under)”, the meaning of not only an upward direction but also a downward direction with respect to one component may be comprised.

The ‘optical axis (see OA of FIG. 29) direction’ used hereinafter is defined as an optical axis direction of a lens and/or image sensor being coupled to a lens driving device.

The ‘vertical direction’ used hereinafter may be a direction parallel to or the same as an optical axis direction. The vertical direction may correspond to a ‘z-axis direction’. The ‘horizontal direction’ used hereinafter may be a direction perpendicular to a vertical direction. That is, a horizontal direction may be a direction perpendicular to the optical axis. Therefore, a horizontal direction may comprise an ‘x-axis direction’and a ‘y-axis direction’.

The ‘auto focus (AF) function’ used hereinafter is defined as a function that automatically focuses on a subject by adjusting the distance from an image sensor by moving the lens in an optical axis direction according to the distance of the subject so that a clear image of the subject can be obtained on an image sensor. In addition, ‘closed-loop auto focus (CLAF) control’ is defined as detecting the distance between an image sensor and a lens and controlling the position of the lens through feedback in real time in order to improve the accuracy of focus adjustment.

The ‘optical image stabilization (OIS) function’ used hereinafter is defined as a function that moves or tilts a lens in a direction perpendicular to the optical axis to offset handshake in order to prevent an image or video from shaking due to the user's handshake. In addition, ‘closed-loop auto focus (CLAF) control’ is defined as detecting the position of a lens with respect to an image sensor and controlling the feedback of the lens position in real time in order to improve the accuracy of handshake correction.

Hereinafter, any one among an “AF moving unit 200” , an “OIS-x moving unit 300”, and an “OIS-y moving unit 400” may be referred to as a “first moving unit”, the other may be referred to as a “second moving unit”, and yet the other may be referred to as a “third moving unit”.

Hereinafter, any one among an “AF drive unit 500”, an “OIS-x drive unit 600”, and an “OIS-y drive unit 700” may be referred to as a “first drive unit”, the other may be referred to as a “second drive unit”, and yet the other may be referred to as a “third drive unit”.

Hereinafter, any one among an “AF magnet 510”, an “OIS-x magnet 610”, an “OIS-y magnet 710” and a “magnet 910” may be referred to as a “first magnet”, the other may be referred to as a “second magnet”, and yet the other may be referred to as a “fourth magnet”.

Hereinafter, any one among an “AF coil 520”, an “OIS-x coil 620”, and an “OIS-y coil 720” may be referred to as a “first coil”, the other may be referred to as a “second coil”, and yet the other may be referred to as a “third coil”.

Hereinafter, one of an “outer substrate 860” and an “inner substrate 870” may be referred to as a “first substrate” and the other may be referred to as a “second substrate”.

Hereinafter, one among an “AF guide ball 810”, an “OIS-x guide ball 820”, and an “OIS-y guide ball 830” may be referred to as a “first ball”, the other may be referred to as a “second ball”, and yet the other may be referred to as a “third ball”.

Hereinafter, one among an “AF sensor 530”, an “OIS-x sensor 630”, and an “OIS-y sensor 730” may be referred to as a “first sensor”, the other may be referred to as a “second sensor”, and yet the other may be referred to as a “third sensor”.

Hereinafter, any one among an “AF yoke 540”, an “OIS-x yoke 640”, an “OIS-y yoke 740”, a “yoke 915”, a “yoke 920”, and a “yoke 950” is referred to as a “first yoke”, the other is referred to as a “second yoke”, yet the other is referred to as a “third yoke”, still the other is referred to as a “fourth yoke”, yet still the other is referred to as a “fifth yoke”, and still yet the other may be referred to as a “sixth yoke”.
Hereinafter, an “AF carrier 210” may be referred to as a “housing.”
Hereinafter, an “OIS-x carrier 310” may be referred to as a “guide frame”.
Hereinafter, an “OIS-y carrier 410” may be referred to as a “bobbin”.

Hereinafter, the configuration of a lens driving device according to the present embodiment is described with reference to the drawings.

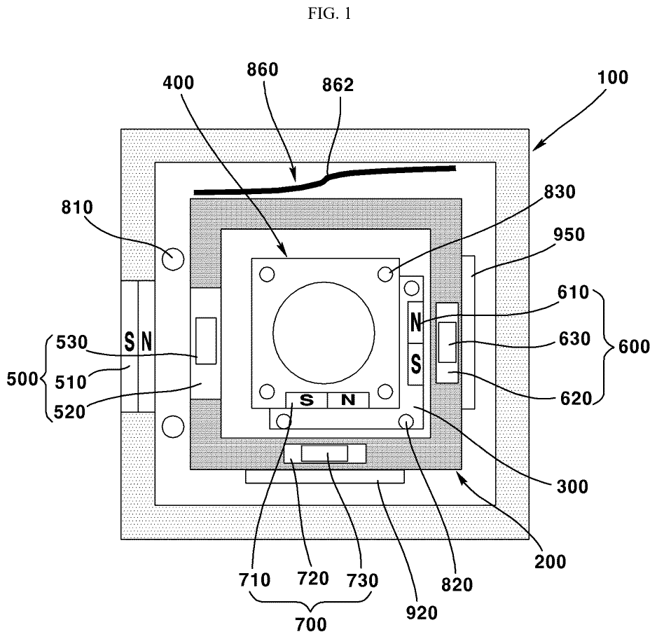

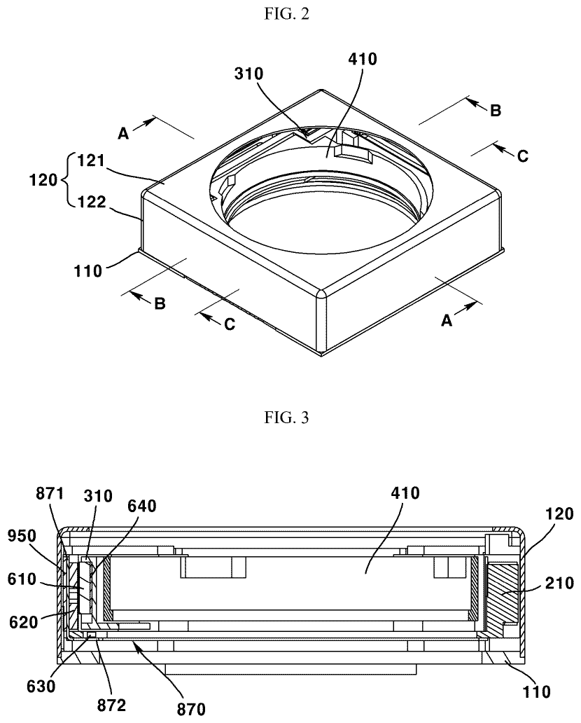

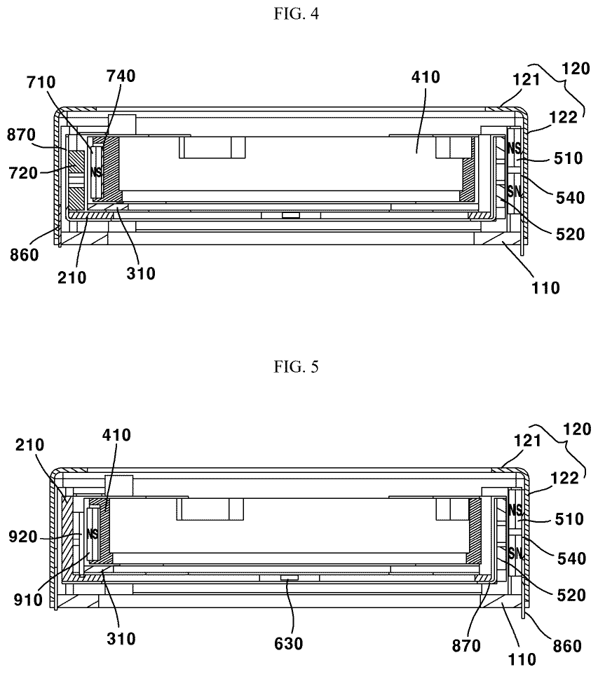

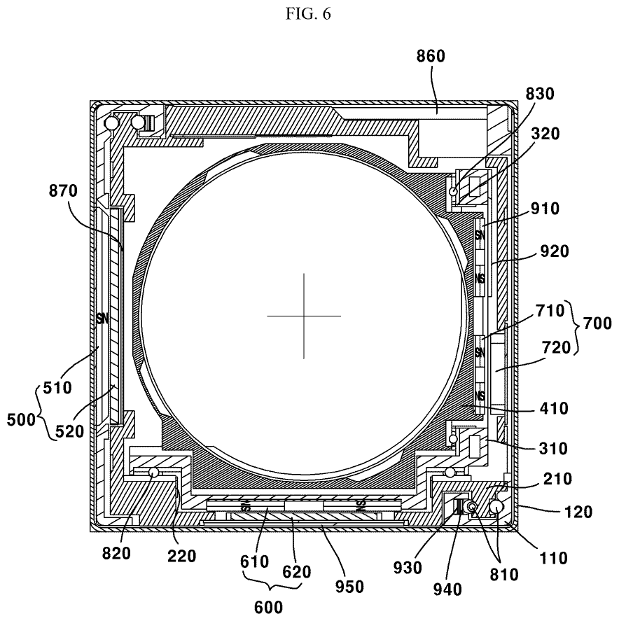

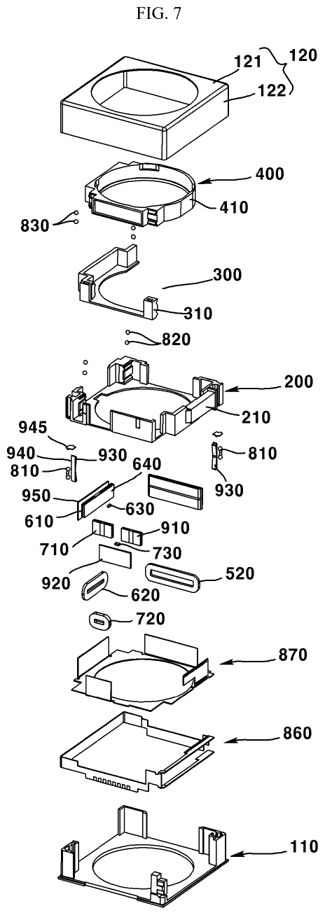

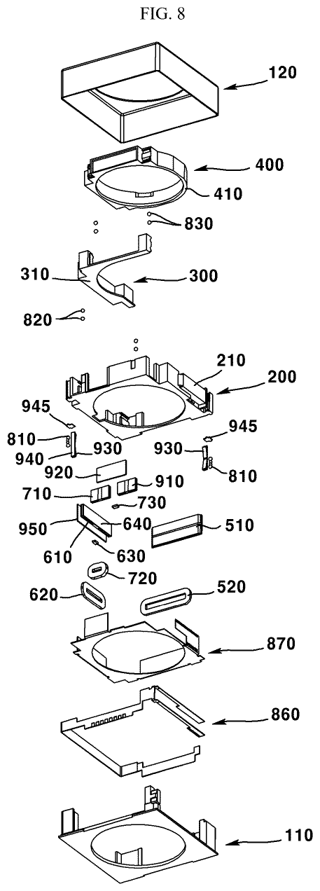

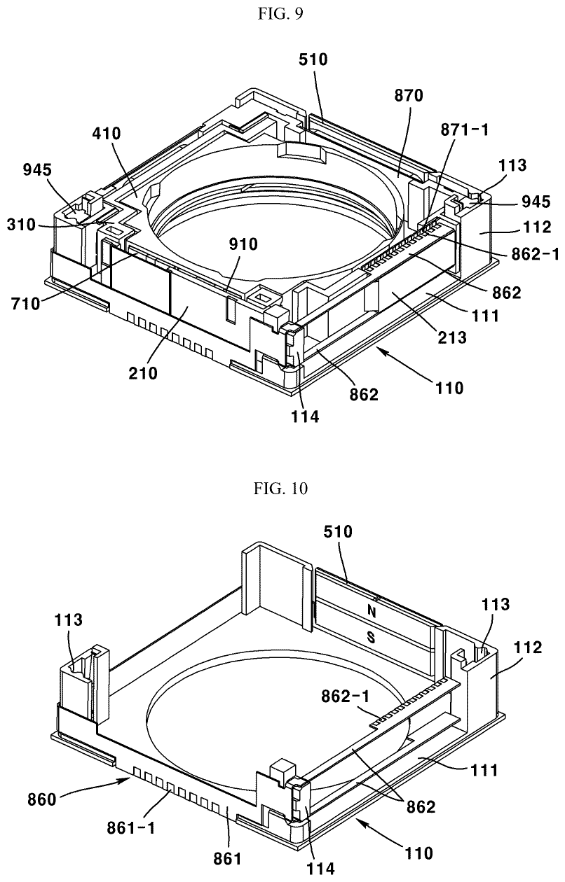

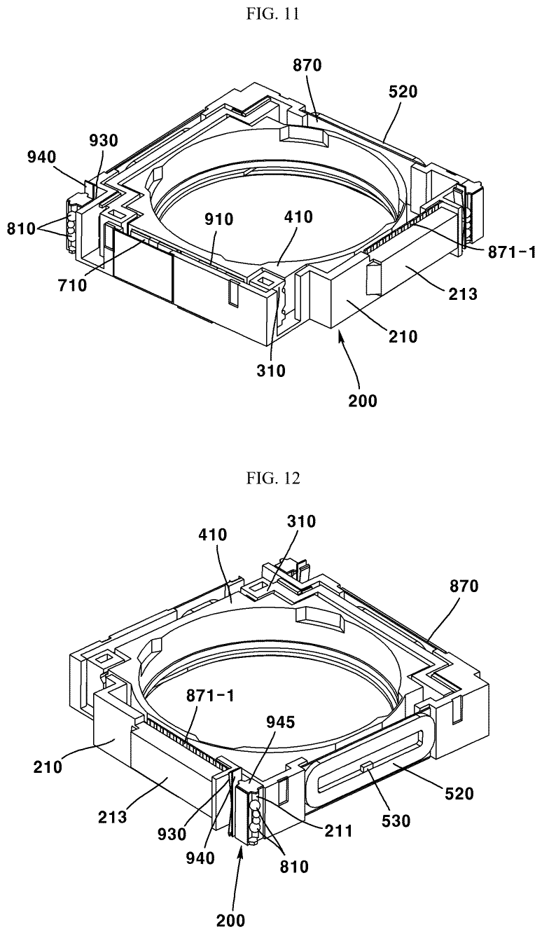

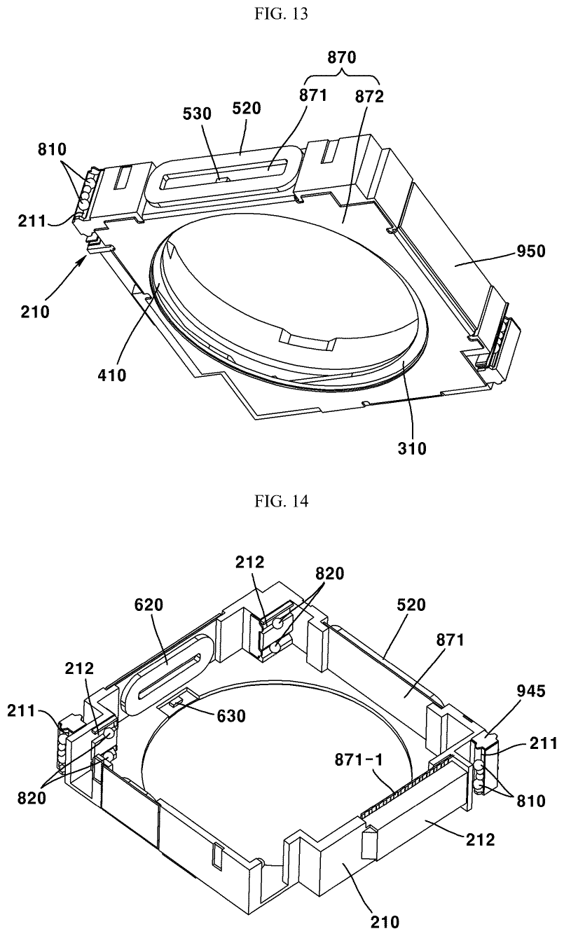

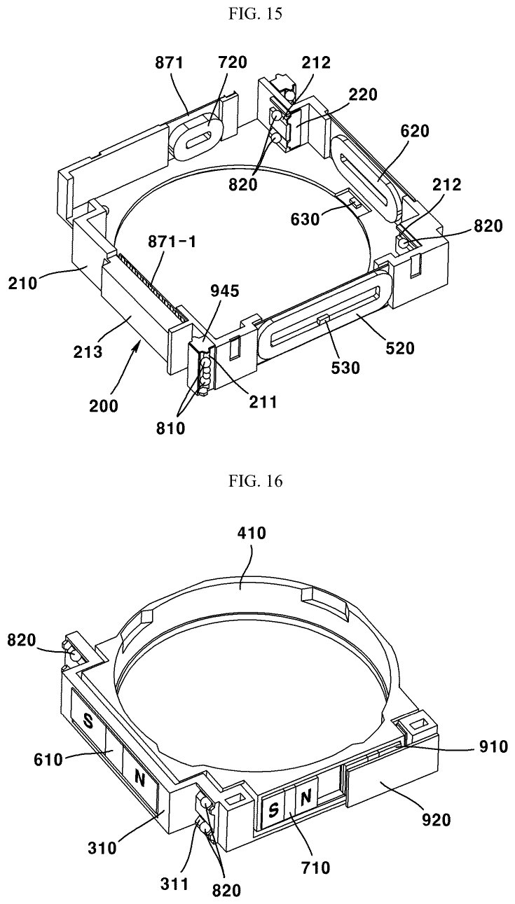

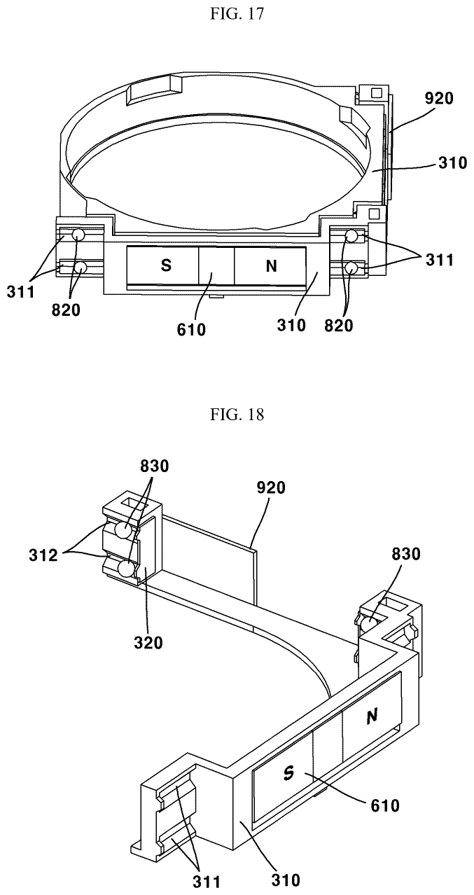

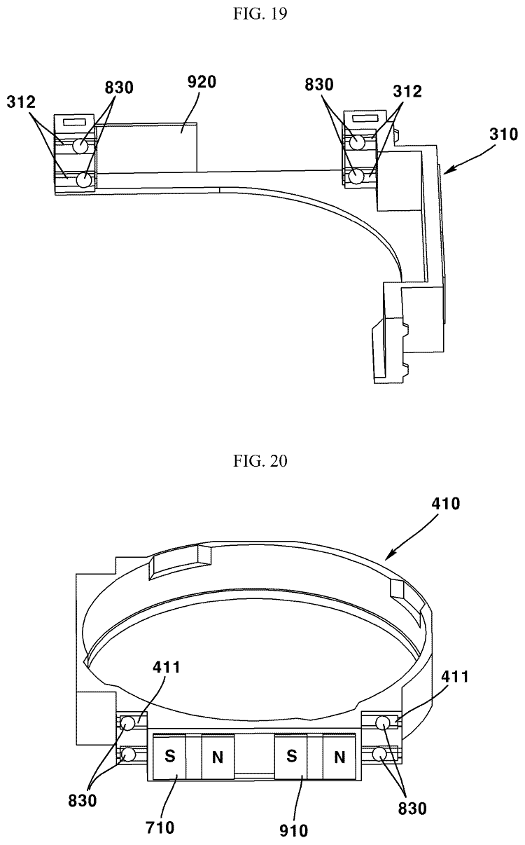

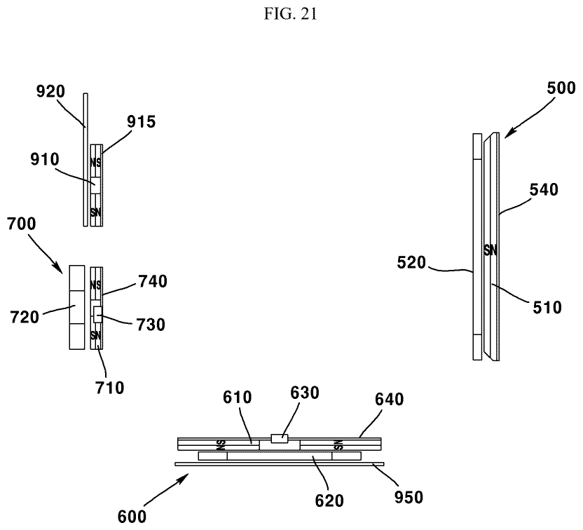

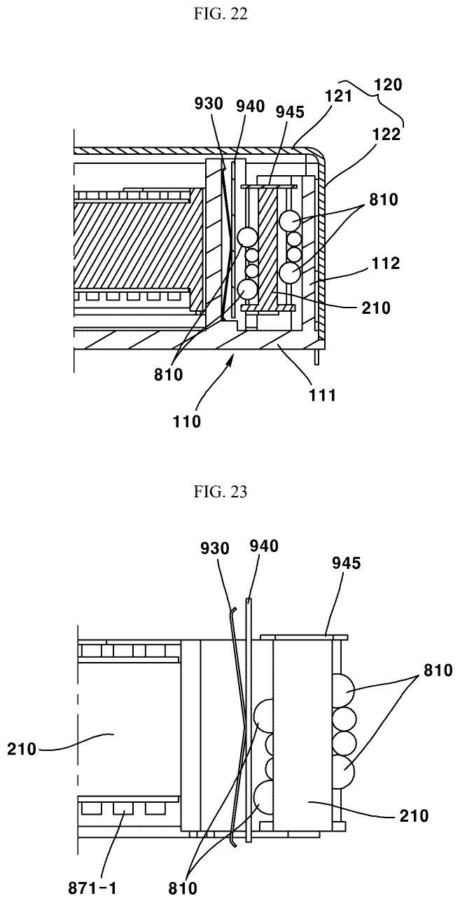

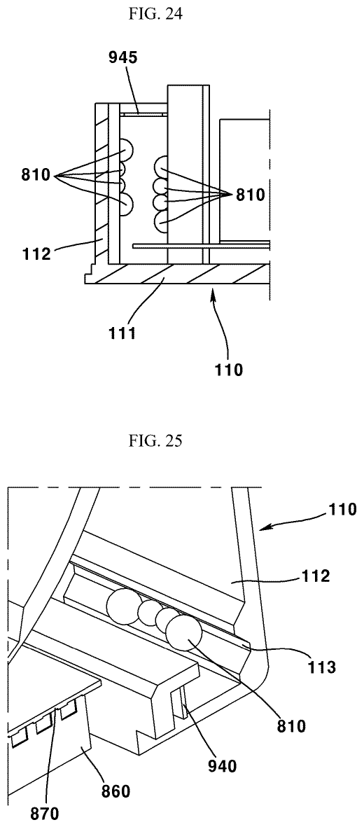

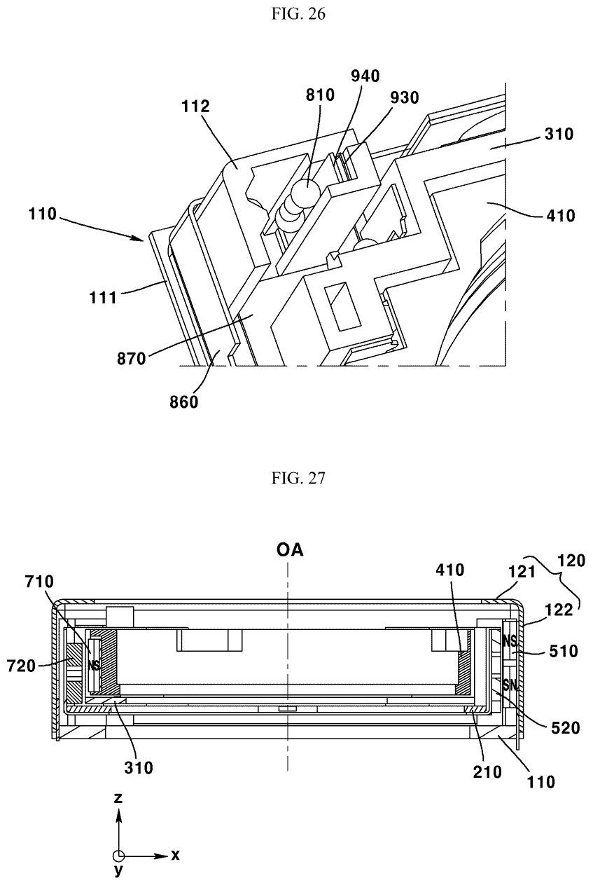

FIG. 1 is a conceptual diagram of a lens driving device according to the present embodiment; FIG. 2 is a perspective view of a lens driving device according to the present embodiment; FIG. 3 is a cross-sectional view taken along line A-A of FIG. 2; FIG. 4 is a cross-sectional view taken along line B-B of FIG. 2; FIG. 5 is a cross-sectional view taken along line C-C of FIG. 2; FIG. 6 is a cross-sectional view of a lens driving device according to the present embodiment cut in a direction perpendicular to an optical axis and viewed from above; FIG. 7 is an exploded perspective view of a lens driving device according to the present embodiment; FIG. 8 is an exploded perspective view of a lens driving device according to the present embodiment viewed from a different direction than FIG. 7; FIG. 9 is a perspective view of a lens driving device according to the present embodiment with a cover omitted; FIG. 10 is a perspective view illustrating a fixed unit and related configuration of a lens driving device according to the present embodiment; FIG. 11 is a perspective view illustrating a moving unit and related configuration of a lens driving device according to the present embodiment; FIG. 12 is a perspective view illustrating a moving unit and related configuration of a lens driving device viewed from a different direction from FIG. 11; FIG. 13 is a bottom perspective view illustrating a moving unit and related configuration of a lens driving device viewed from a different direction from FIG. 11 and FIG. 12; FIG. 14 is a perspective view illustrating an AF moving unit and related configuration of a lens driving device according to the present embodiment; FIG. 15 is a perspective view illustrating an AF moving unit and related configuration of a lens driving device viewed from a different direction from FIG. 14; FIG. 16 is a perspective view illustrating an OIS moving unit and related configuration of a lens driving device according to the present embodiment; FIG. 17 is a perspective view illustrating an OIS moving unit and related configuration of a lens driving device viewed from a different direction from FIG. 16; FIG. 18 is a perspective view illustrating an OIS-x moving unit and related configuration of a lens driving device according to the present embodiment; FIG. 19 is a perspective view illustrating an OIS-x moving unit and related configuration of a lens driving device viewed from a different direction than FIG. 18; FIG. 20 is a perspective view illustrating an OIS-y moving unit and related configuration of a lens driving device according to the present embodiment; FIG. 21 is a bottom view illustrating a drive unit and related configuration of a lens driving device according to the present embodiment; FIG. 22 is a cross-sectional view illustrating an AF guide ball and related configuration of a lens driving device according to the present embodiment; FIG. 23 is a side view illustrating an AF guide ball and related configuration with the base omitted; FIG. 24 is a cross-sectional view illustrating an AF guide ball and related configuration with the AF carrier omitted; FIG. 25 is a perspective view illustrating an AF guide ball and related configuration with the AF carrier omitted; and FIG. 26 is a perspective view illustrating an AF guide ball and related configuration with the AF carrier omitted, viewed from a different direction than FIG. 25.

The lens driving device 10 may be a voice coil motor (VCM). The lens driving device 10 may be a lens driving motor. The lens driving device 10 may be a lens driving actuator. The lens driving device 10 may comprise an AF module. The lens driving device 10 may comprise an OIS module.

The lens driving device 10 may comprise a fixed unit 100. The fixed unit 100 may be a portion that is relatively fixed when the moving unit moves. The moving unit may move with respect to the fixed unit 100.

The lens driving device 10 may comprise a base 110. The fixed unit 100 may comprise a base 110. The base 110 may be disposed under the AF carrier 210. The base 110 may be disposed under the OIS-x carrier 310. The base 110 may be disposed under the OIS-y carrier 410. The base 110 may be coupled with the cover 120. The AF carrier 210, the OIS-x carrier 310, and the OIS-y carrier 410 may be disposed on the base 110. The AF carrier 210, the OIS-x carrier 310, and the OIS-y carrier 410 may be disposed on the lower plate portion 111 of the base 110. The AF carrier 210, the OIS-x carrier 310, and the OIS-y carrier 410 may be disposed inside the base 110. The AF carrier 210, the OIS-x carrier 310, and the OIS-y carrier 410 may be disposed inside the side wall portion 112 of the base 110.

The base 110 may comprise a lower plate portion 111. The base 110 may comprise a side wall portion 112. The side wall portion 112 may be a ‘side portion’. The side wall portion 112 may be a ‘side plate’. The side wall portion 112 may be a ‘side wall’. The side wall portion 112 of the base 110 may be extended from an upper surface of the lower plate portion 111.

The side wall portion 112 of the base 110 may comprise a plurality of side walls. The side wall portion 112 of the base 110 may comprise four side walls. The side wall portion 112 of the base 110 may comprise first to fourth side walls. The side wall portion 112 of the base 110 may comprise a first side wall and a second side wall being disposed opposite to each other, and a third side wall and a fourth side wall being disposed opposite to each other. At this time, the AF magnet 510 may be disposed on a first side plate of the base 110. The OIS-x magnet 610 may be disposed on a position corresponding to the third side plate of the base 110. The OIS-y magnet 710 may be disposed on a position corresponding to the second side plate of the base 110.

The base 110 may comprise a groove 113. The groove 113 may be an ‘AF guide ball accommodating groove’. An AF guide ball 810 may be disposed in the groove 113. The groove 113 may be in direct contact with the AF guide ball 810. The groove 113 may be disposed in an optical axis direction. The groove 113 may comprise a plurality of grooves. The groove 113 may comprise two grooves. The two grooves may be disposed parallel to each other. The groove 113 may comprise a first groove being in contact with the AF guide ball 810 at two points, and a second groove being in contact with the AF guide ball 810 at one point. In a modified embodiment, both the first groove and the second groove may come into contact with the AF guide ball 810 at two points.

The base 110 may comprise a protruded portion 114. The protruded portion 114 may be protruded outwardly. A connection portion 712 of an outer substrate 710 may be disposed above and below the protruded portion 114. A groove may be formed in the protruded portion 114 so as not to interfere even when the connection portion 712 of the outer substrate 710 moves.

The base 110 may comprise a step. The step may be formed at a lower end of an outer side surface of the base 110. The step may be protruded from an outer side surface of the base 110. A side plate 122 of the cover 120 may be disposed in the step of the base 110.

The lens driving device 10 may comprise a cover 120. The fixed unit 100 may comprise a cover 120. The cover 120 may be disposed in the base 110. The cover 120 may be disposed on the base 110. The cover 120 may be coupled to the base 110. The cover 120 may be fixed to the base 110. The cover 120 may accommodate an AF carrier 210 therein. The cover 120 may accommodate an OIS-x carrier 310 and an OIS-y carrier 410 therein. The cover 120 may be a shield member. The cover 120 may be a shield can.

The cover 120 may comprise an upper plate 121. The upper plate 121 may be disposed on the moving unit. The upward movement of the moving unit may be limited by the moving unit being in contact with the upper plate 121. The upper plate 121 may comprise a hole through which light passes.

The cover 120 may comprise a side plate 122. The side plate 122 may be extended from the upper plate 121. The side plate 122 may be disposed in the base 110. The side plate 122 may be disposed on a step portion being protruded from a lower end portion of an outer side surface of the base 110. The side plate 122 may comprise a plurality of side plates. The side plate 122 may comprise four side plates. The side plate 122 may comprise a first side plate and a second side plate being disposed opposite each other and a third side plate and a fourth side plate being disposed opposite each other.

The lens driving device 10 may comprise a moving unit. The moving unit may be disposed in the fixed unit 100. The moving unit may be disposed in the fixed unit 100. The moving unit may be disposed inside the fixed unit 100. The moving unit may be movably disposed on the fixed unit 100. The moving unit may be moved with respect to the fixed unit 100 by the drive unit. The moving unit may be moved during AF driving. The moving unit may be moved during OIS driving. A lens may be coupled to the moving unit.

The lens driving device 10 may comprise an AF moving unit 200. The moving unit may comprise an AF moving unit 200. The AF moving unit 200 may be disposed in the fixed unit 100. The AF moving unit 200 may be disposed inside the fixed unit 100. The AF moving unit 200 may be disposed on the fixed unit 100. The AF moving unit 200 may be disposed between the fixed unit 100 and the OIS moving unit. The AF moving unit 200 may be movably disposed in the fixed unit 100. The AF moving unit 200 may be moved in an optical axis direction against the fixed unit 100 by the AF drive unit 500. The AF moving unit 200 may be moved during AF driving.

The lens driving device 10 may comprise an AF carrier 210. The AF moving unit 200 may comprise an AF carrier 210. The AF carrier 210 may be an ‘AF holder’. The AF carrier 210 may be a ‘housing’. The AF carrier 210 may be disposed inside the base 110. The AF carrier 210 may be disposed on the base 110. The AF carrier 210 may be disposed inside the cover 120. The AF carrier 210 may be disposed between the base 110 and the OIS-x carrier 310. The AF carrier 210 may be disposed between the base 110 and the OIS-y carrier 410. The AF carrier 210 may be movably disposed in an optical axis direction.

The AF carrier 210 may comprise a groove 211. The holder member 220 may comprise a groove 211. The groove 211 may be an ‘AF guide ball accommodating groove’. An AF guide ball 810 may be groove in the groove 211. The groove 211 may be in direct contact with the AF guide ball 810. The groove 211 may be groove in an optical axis direction. The groove 211 may guide the AF guide ball 810 to move in an optical axis direction. The groove 211 may comprise a plurality of grooves. The groove 211 may comprise two grooves. The two grooves may be groove parallel to each other. The groove 211 may comprise a first groove being in contact with the AF guide ball 810 at two points, and a second groove being in contact with the AF guide ball 810 at one point. In a modified embodiment, both the first groove and the second groove can come into contact with the AF guide ball 810 at two points.

The AF carrier 210 may comprise a groove 212. The groove 212 may be an ‘OIS-x guide ball accommodating groove’. The groove 212 may be formed on a side wall of the AF carrier 210. The groove 212 may be formed on an inner surface of a side wall of the AF carrier 210. The groove 212 may be formed on an inner surface of the AF carrier 210. The groove 212 may be groove in an x-axis direction. An OIS-x guide ball 820 may be groove in the groove 212. The groove 212 may guide the OIS-x guide ball 820 to move in an x-axis direction. The groove 212 may be in direct contact with the OIS-x guide ball 820. The groove 212 may comprise a plurality of grooves. The groove 212 may comprise four grooves.

The AF carrier 210 may comprise a protruded portion 213. The protruded portion 213 may be formed on an outer side surface of the AF carrier 210. The protruded portion 213 may be protruded outwardly from the AF carrier 210. A connection portion 862 of an outer substrate 860 may be groove on an upper surface and a lower surface of the protruded portion 213.

Hereinafter, one of the “groove 211” and the “groove 212” of the AF carrier 210 may be referred to as a “first groove” and the other may be referred to as a “second groove”.

The lens driving device 10 may comprise an OIS moving unit. The moving unit may comprise an OIS moving unit. The OIS moving unit may be disposed in the fixed unit 100. The OIS moving unit may be disposed inside the fixed unit 100. The OIS moving unit may be disposed on the fixed unit 100. The OIS moving unit may be disposed inside the fixed unit 200. The OIS moving unit may be disposed inside the AF moving unit 200. The OIS moving unit may be movably disposed. The OIS moving unit may move in a direction perpendicular to the optical axis against the fixed unit 100 and the AF moving unit 200 by the OIS drive unit. The OIS moving unit may be moved during OIS driving.

The lens driving device 10 may comprise an OIS-x moving unit 300. The OIS moving unit may comprise an OIS-x moving unit 300. The OIS-x moving unit 300 may be disposed in the fixed unit 100. The OIS-x moving unit 300 may be disposed inside the fixed unit 100. The OIS-x moving unit 300 may be disposed on the fixed unit 100. The OIS-x moving unit 300 may be disposed inside the AF moving unit 200. The OIS-x moving unit 300 may be disposed between the fixed unit 100 and the OIS-moving unit 400. The OIS-x moving unit 300 may be disposed between the fixed unit 100 and the OIS-moving unit 400. The OIS-x moving unit 300 may be disposed between the AF moving unit 200 and the OIS-moving unit 400. The OIS-x moving unit 300 may be movably disposed. The OIS-x moving unit 300 may move in an x-axis direction perpendicular to the optical axis against the fixed unit 100 and the AF moving unit 200 by the OIS-x drive unit 600. The OIS-x moving unit 300 may move during OIS driving.

The lens driving device 10 may comprise an OIS-x carrier 310. The OIS-x moving unit 300 may comprise an OIS-x carrier 310. The OIS-x carrier 310 may be an OIS-x holder. The OIS-x carrier 310 may be disposed inside the AF carrier 210. The OIS-x carrier 310 may be disposed inside the base 110. The OIS-x carrier 310 may be disposed on the base 110. The OIS-x carrier 310 may be disposed inside the cover 140. The OIS-x carrier 310 may be disposed between the base 110 and the OIS-y carrier 410. The OIS-x carrier 310 may be disposed between the AF carrier 210 and the OIS-y carrier 410. The OIS-x carrier 310 may be disposed between the AF carrier 210 and the OIS-y carrier 410. The OIS-x carrier 310 may be movably disposed in an x-axis direction perpendicular to the optical axis.

The OIS-x carrier 310 may comprise a groove 311. The groove 311 may be an ‘OIS-x guide ball accommodating groove’. An OIS-x guide ball 820 may be disposed in the groove 311. The groove 311 may be in direct contact with the OIS-x guide ball 820. The groove 311 may be disposed in a direction perpendicular to the optical axis. The groove 311 may be disposed in an x-axis direction. The groove 311 may guide the OIS-x guide ball 820 to move in an x-axis direction. The groove 311 may comprise a plurality of grooves. The groove 311 may comprise four grooves. The groove 311 may comprise a first groove being in contact with the OIS-x guide ball 820 at two points, and a second groove being in contact with the OIS-x guide ball 820 at one point. In a modified embodiment, both the first groove and the second groove can be in contact with the OIS-x guide ball 820 at two points.

The OIS-x carrier 310 may comprise a groove 312. The groove 312 may be an ‘OIS-y guide ball accommodating groove’. An OIS-y guide ball 830 may be disposed in the groove 312. The groove 312 may be in direct contact with the OIS-y guide ball 830. The groove 312 may be disposed in a direction perpendicular to the optical axis. The groove 312 may be disposed in a y-axis direction. The groove 312 may movably guide the OIS-y guide ball 830 in a y-axis direction. The groove 312 may comprise a plurality of grooves. The groove 312 may comprise four grooves. The groove 312 may comprise a first groove being in contact with the OIS-y guide ball 830 at two points, and a second groove being in contact with the OIS-y guide ball 830 at one point. In a modified embodiment, both the first groove and the second groove can be in contact with the OIS-y guide ball 830 at two points.

The OIS-x carrier 310 may comprise a groove. The groove may be a ‘magnet accommodating groove’. The groove may be formed on an outer side surface of the OIS-x carrier 310. An OIS-x magnet 610 may be disposed in the groove. The groove may be formed in a shape corresponding to the OIS-x magnet 610.

Hereinafter, one among a “groove 311”, a “groove 312”, and a “magnet accommodating groove” of the OIS-x carrier 310 is referred to as a “first groove”, the other is referred to as a “second groove”, and yet the other may be referred to as a “third groove”.

The lens driving device 10 may comprise an OIS-y moving unit 400. The OIS moving unit may comprise an OIS-y moving unit 400. The OIS-y moving unit 400 may be disposed in the fixed unit 100. The OIS-y moving unit 400 may be disposed inside the fixed unit 100. The OIS-y moving unit 400 may be disposed on the fixed unit 100. The OIS-y moving unit 400 may be disposed inside the AF moving unit 200. The OIS-y moving unit 400 may be disposed inside the OIS-x moving unit 300. The OIS-y moving unit 400 may be movably disposed. The OIS-y moving unit 400 can move in a y-axis direction perpendicular to both the optical axis and the x-axis against the fixed unit 100, the AF moving unit 200, and the OIS-x moving unit 300 by the OIS-y drive unit 700. The OIS-y moving unit 400 can move during OIS driving.

The lens driving device 10 may comprise an OIS-y carrier 410. The OIS-y moving unit 400 may comprise an OIS-y carrier 410. The OIS-y carrier 410 may be a ‘bobbin’. The OIS-y carrier 410 may be an ‘OIS-y holder’. The OIS-y carrier 410 may be disposed inside the OIS-x carrier 310. The OIS-y carrier 410 may be disposed inside the AF carrier 210. The OIS-y carrier 410 may be disposed inside the base 110. The OIS-y carrier 410 may be disposed on the base 110. The OIS-y carrier 410 may be disposed inside the cover 140. The OIS-y carrier 410 can be movably disposed in a y-axis direction perpendicular to both the optical axis and the x-axis.

The OIS-y carrier 410 may comprise a groove 411. The groove 411 may be an ‘OIS-y guide ball accommodating groove’. An OIS-y guide ball 830 may be disposed in the groove 411. The groove 411 may be in direct contact with the OIS-y guide ball 830. The groove 411 may be disposed in a direction perpendicular to the optical axis. The groove 411 may be disposed in a y-axis direction. The groove 411 may movably guide the OIS-y guide ball 830 in a y-axis direction. The groove 411 may comprise a plurality of grooves. The groove 411 may comprise four grooves. The groove 411 may comprise a first groove being in contact with the OIS-y guide ball 830 at two points, and a second groove being in contact with the OIS-y guide ball 830 at one point. In a modified embodiment, both the first groove and the second groove may be in contact with the OIS-y guide ball 830 at two points.

The OIS-y carrier 410 may comprise a groove. The groove may be a ‘magnet accommodating groove’. The groove may be formed on an outer side surface of the OIS-y carrier 410. An OIS-y magnet 710 may be disposed in the groove. The groove may be formed in a shape corresponding to the OIS-y magnet 710.

Hereinafter, one of a “groove 411” and a “magnet accommodating groove” of the OIS-y carrier 410 is referred to as a “first groove” and the other may be referred to as a “second groove”.

The lens driving device 10 may comprise a drive unit. The drive unit may move the moving unit against the fixed unit 100. The drive unit may comprise an AF drive unit 500. The drive unit may comprise an OIS drive unit. The drive unit may comprise an OIS-x drive unit 600. The drive unit may comprise an OIS-y drive unit 700. The drive unit may comprise a coil and a magnet.

The lens driving device 10 may comprise an AF drive unit 500. The AF drive unit 500 may move the AF moving unit 200 in an optical axis direction. The AF drive unit 500 may move the AF carrier 210 in an optical axis direction. The AF drive unit 500 may move the AF carrier 210 in an optical axis direction through electromagnetic force. The AF drive unit 500 may comprise a coil and a magnet.

In the present embodiment, the AF carrier 210, the OIS-x carrier 310, and the OIS-y carrier 410 can move in an optical axis direction by the interaction between the AF coil 520 and the AF magnet 510. The AF coil 520, the AF carrier 210, the OIS-x carrier 310, and the OIS-y carrier 410 can move integrally in an optical axis direction. The AF coil 520, the OIS-x coil 620, the OIS-y coil 720, the AF carrier 210, the OIS-x carrier 310, and the OIS-y carrier 410 can move integrally in an optical axis direction.

The lens driving device 10 may comprise an AF magnet 510. The AF drive unit 500 may comprise an AF magnet 510. The AF magnet 510 may be an ‘AF magnet’. The AF magnet 510 may be a permanent magnet. The AF magnet 510 may be disposed in the fixed unit 100. The AF magnet 510 may be disposed in the base 110. The AF magnet 510 may be disposed in the cover 120. The AF magnet 510 may be disposed in the side plate 122 of the cover 120. The AF magnet 510 may be disposed on an outer side surface of the base 110. The AF magnet 510 may be disposed on the inner side surface of the base 110. The AF magnet 510 may be disposed in the side wall portion 112 of the base 110. The AF magnet 510 may be fixed to the base 110. The AF magnet 510 may be coupled to the base 110. The AF magnet 510 may be attached to the base 110 with an adhesive. The AF magnet 510 may be disposed inside the cover 120. The AF magnet 510 may interact with the AF coil 520. The AF magnet 510 may electromagnetically interact with the AF coil 520. The AF magnet 510 may be disposed at a position corresponding to the AF coil 520. The AF magnet 510 and the AF coil 520 may face each other. The AF magnet 510 may face the AF coil 520. The AF magnet 510 may be overlapped with the AF coil 520 in a direction perpendicular to the optical axis. The AF magnet 510 may be overlapped with the AF coil 520 in an x-axis direction.

The AF magnet 510 may be a four-pole magnet. The AF magnet 510 may comprise a four-pole magnetizing magnet. The AF magnet 510 may comprise a first magnet portion comprising an N pole and an S pole, and a second magnet portion comprising an N pole and an S pole. The first magnet portion and the second magnet portion may be disposed in a vertical direction. The first magnet portion and the second magnet portion may be spaced apart in a vertical direction. A neutral portion may be disposed between the first magnet portion and the second magnet portion.

The lens driving device 10 may comprise an AF coil 520. The AF drive unit 500 may comprise an AF coil 520. The AF coil 520 may interact with an AF magnet 510. The AF coil 520 and the AF magnet 510 may face each other. The AF coil 520 may face the AF magnet 510. The AF coil 520 may be disposed at a position corresponding to the AF magnet 510. The AF coil 520 may be overlapped with the AF magnet 510 in a direction perpendicular to the optical axis. The AF coil 520 may be disposed on an inner substrate 720. The AF coil 520 may be disposed in an AF carrier 210. The AF coil 520 can be disposed in the AF carrier 210 through the inner substrate 720. The AF coil 520 can move integrally with the AF carrier 210.

In the present embodiment, the AF coil 520 can move in an optical axis direction. The AF coil 520 can move in an optical axis direction through interaction with the AF magnet 510. The AF coil 520 can move together with the AF moving unit 200. The AF coil 520 can move together with the AF moving unit 200 in an optical axis direction. During the AF driving process, the AF coil 520 can move together with the AF moving unit 200 in an optical axis direction. The AF coil 520 can be disposed in the AF moving unit 200. The AF coil 520 can be fixed to the AF moving unit 200. The AF coil 520 can be coupled to the AF moving unit 200.

The lens driving device 10 may comprise an AF sensor 530. The AF drive unit 500 may comprise an AF sensor 530. The AF sensor 530 may be a Hall sensor. The AF sensor 530 may be disposed in an inner substrate 720. The AF sensor 530 may detect the AF magnet 510. The AF sensor 530 may detect the movement of the AF magnet 510. The movement amount or position of the AF magnet 510 detected by the AF sensor 530 may be used for feedback of auto focus driving. The AF sensor 530 may be disposed in the AF moving unit 200. The AF sensor 530 may be disposed in the AF carrier 210. The AF sensor 530 may be disposed in the AF carrier 210 through the inner substrate 720. The AF sensor 530 can move together with the AF moving unit 200.

The AF sensor 530 may be a driver IC. The driver IC may comprise a sensing unit. The sensing unit may comprise a Hall element (Hall IC). The driver IC may be electrically connected to the AF coil 520. The driver IC may supply current to the AF coil 520.

The AF sensor 530 may be disposed inside the AF coil 520. The AF sensor 530 may be overlapped with the neutral portion of the AF magnet 510 in a direction perpendicular to the optical axis. In a modified embodiment, the AF sensor 530 may be disposed outside the AF coil 520.

The lens driving device 10 may comprise an AF yoke 540. The AF yoke 540 may be disposed corresponding to the AF magnet 510. The AF yoke 540 may be disposed in the AF magnet 510. The AF yoke 540 may be disposed between the AF magnet 510 and the side plate 122 of the cover 120. The AF yoke 540 may be disposed on the outer surface of the AF magnet 510. The inner surface of the AF magnet 510 may face the AF coil 520. Through this, the AF yoke 540 may minimize the leakage flux of the AF magnet 510 and increase the electromagnetic interaction force between the AF magnet 510 and the AF coil 520.

The lens driving device 10 may comprise an OIS drive unit. The OIS drive unit may move the OIS moving unit in a direction perpendicular to the optical axis direction. The OIS drive unit may move an OIS-x carrier 310 and an OIS-y carrier 410 in a direction perpendicular to the optical axis. The OIS drive unit may move the OIS-x carrier 310 and the OIS-y carrier 410 in a direction perpendicular to the optical axis through electromagnetic force. The OIS drive unit may comprise a magnet and a coil.

The lens driving device 10 may comprise an OIS-x drive unit 600. The OIS drive unit may comprise an OIS-x drive unit 600. The OIS-x drive unit 600 may move an OIS-x moving unit 300 in an x-axis direction perpendicular to the optical axis direction. The OIS-x drive unit 600 may move the OIS-x carrier 310 in an x-axis direction. The OIS-x drive unit 600 may move the OIS-x carrier 310 and the OIS-y carrier 410 in an x-axis direction perpendicular to the optical axis. The OIS-x drive unit 600 may move the OIS-x carrier 310 and the OIS-y carrier 410 in an x-axis direction perpendicular to the optical axis using an electromagnetic force. The OIS-x drive unit 600 may comprise a coil and a magnet.

In the present embodiment, the OIS-x magnet 610 and the OIS-x coil 620 can move the OIS moving unit in an x-axis direction perpendicular to the optical axis direction. By the interaction of the OIS-x coil 620 and the OIS-x magnet 610, the OIS-x carrier 310 and the OIS-y carrier 410 can move in an x-axis direction perpendicular to the optical axis direction. The OIS-x magnet 610, the OIS-x carrier 310, and the OIS-y carrier 410 can move integrally in an x-axis direction.

The lens driving device 10 may comprise an OIS-x magnet 610. The OIS drive unit may comprise an OIS-x magnet 610. The OIS-x magnet 610 may be an ‘OIS-x magnet’. The OIS-x magnet 610 may be a permanent magnet. The OIS-x magnet 610 may be disposed in the OIS moving unit. The OIS-x magnet 610 may be spaced apart from the AF magnet 510. The OIS-x magnet 610 may be disposed in the OIS-x moving unit 300. The OIS-x magnet 610 may be disposed in the OIS-x carrier 310. The OIS-x magnet 610 may be disposed on an outer side surface of the OIS-x carrier 310. The OIS-x magnet 610 can be fixed to the OIS-x carrier 310. The OIS-x magnet 610 can be coupled to the OIS-x carrier 310. The OIS-x magnet 610 can be attached to the OIS-x carrier 310 with an adhesive. The OIS-x magnet 610 can be disposed inside the cover 120. The OIS-x magnet 610 can interact with the OIS-x coil 620. The OIS-x magnet 610 can electromagnetically interact with the OIS-x coil 620. The OIS-x magnet 610 can be disposed at a position corresponding to the OIS-x coil 620. The OIS-x magnet 610 and the OIS-x coil 620 may face each other. The OIS-x magnet 610 can face the OIS-x coil 620. The OIS-x magnet 610 can be overlapped with the OIS-x coil 620 in a direction perpendicular to the optical axis. The OIS-x magnet 610 can be overlapped with the OIS-x coil 620 in a y-axis direction. The OIS-x magnet 610 can move in an x-axis direction.

The OIS-x magnet 610 may be a four-pole magnet. The OIS-x magnet 610 may comprise a four-pole magnetizing magnet. The OIS-x magnet 610 may comprise a first magnet portion comprising an N pole and an S pole, and a second magnet portion comprising an N pole and an S pole. The first magnet portion and the second magnet portion may be disposed in a horizontal direction. The first magnet portion and the second magnet portion may be spaced apart in a horizontal direction. A neutral portion may be disposed between the first magnet portion and the second magnet portion.

The lens driving device 10 may comprise an OIS-x coil 620. The OIS drive unit may comprise an OIS-x coil 620. The OIS-x coil 620 may interact with an OIS-x magnet 610. The OIS-x coil 620 may move the OIS-x magnet 610 in an x-axis direction perpendicular to the optical axis. The OIS-x coil 620 may move the OIS-x magnet 610 in an x-axis direction through interaction with the OIS-x magnet 610. The OIS-x coil 620 and the OIS-x magnet 610 may face each other. The OIS-x coil 620 may face the OIS-x magnet 610. The OIS-x coil 620 may be disposed at a position corresponding to the OIS-x magnet 610. The OIS-x coil 620 may be overlapped with the OIS-x magnet 610 in a direction perpendicular to the optical axis. The OIS-x coil 620 may be overlapped with the OIS-x magnet 610 in a y-axis direction. The OIS-x coil 620 may be disposed in the inner substrate 720. The OIS-x coil 620 may be disposed in the AF carrier 210. The OIS-x coil 620 may be disposed in the AF carrier 210 through the inner substrate 720. The OIS-x coil 620 may move integrally with the AF moving unit 200.

In the present embodiment, the OIS-x coil 620 can move together with the AF moving unit 200. The OIS-x coil 620 can move in an optical axis direction together with the AF moving unit 200. During the AF driving process, the OIS-x coil 620 can move in an optical axis direction together with the AF moving unit 200. The OIS-x coil 620 can be disposed in the AF moving unit 200. The OIS-x coil 620 can be fixed to the AF moving unit 200. The OIS-x coil 620 can be coupled to the AF moving unit 200.

The lens driving device 10 may comprise an OIS-x sensor 630. The OIS drive unit may comprise an OIS-x sensor 630. The OIS-x sensor 630 may be disposed in an inner substrate 720. The OIS-x sensor 630 may be disposed in an AF carrier 210. The OIS-x sensor 630 may be disposed in an OIS moving unit 200. The OIS-x sensor 630 may comprise a Hall sensor. The OIS-x sensor 630 may detect an OIS-x magnet 610. The OIS-x sensor 630 may detect a magnetic force of the OIS-x magnet 610. The OIS-x sensor 630 may be disposed at a lower side of the OIS magnet 520. The OIS-x sensor 630 may be overlapped with the OIS-magnet 520 in an optical axis direction. In a modified embodiment, the OIS-x sensor 630 may be disposed inside the OIS-x coil 620. At this time, the OIS-x sensor 630 may be overlapped with the OIS-x coil 620 in an optical axis direction. The OIS-x sensor 630 may face the OIS-x magnet 610. The OIS-x sensor 630 may be disposed at a position corresponding to the OIS-x magnet 610. The OIS-x sensor 630 may detect the movement of the OIS-x magnet 610. The amount of movement or position of the OIS-x magnet 610 detected by the OIS-x sensor 630 may be used for feedback of the handshake correction drive in an x-axis direction.

The lens driving device 10 may comprise an OIS-x yoke 640. The OIS-x yoke 640 may be disposed in the OIS-x magnet 610. The OIS-x yoke 640 may be disposed between the OIS-x magnet 610 and the OIS-x carrier 310. The OIS-x yoke 640 may prevent magnetic flux leakage of the OIS-x magnet 610 and enhance interaction force with the OIS-x coil 620.

The lens driving device 10 may comprise an OIS-y drive unit 700. The OIS drive unit may comprise an OIS-y drive unit 700. The OIS-y drive unit 700 may move the OIS-y moving unit 400 in a y-axis direction perpendicular to both the optical axis direction and the x-axis direction. The OIS-y drive unit 700 may move the OIS-y carrier 410 in a y-axis direction perpendicular to both the optical axis and the x-axis direction. The OIS-y drive unit 700 may move the OIS-y carrier 410 in a y-axis direction perpendicular to both the optical axis and the x-axis direction through electromagnetic force. The OIS-y drive unit 700 may comprise a coil and a magnet.

In the present embodiment, the OIS-y magnet 710 and the OIS-y coil 720 can move the OIS moving unit in a y-axis direction perpendicular to the optical axis direction and the x-axis direction. By the interaction of the OIS-y coil 720 and the OIS-y magnet 710, the OIS-y carrier 410 can move in an y-axis direction perpendicular to both the optical axis direction and the x-axis direction. The OIS-y magnet 710 and the OIS-y carrier 410 can move integrally in a y-axis direction. The OIS-y magnet 710 can be overlapped with the AF magnet 510 in an x-axis direction.

The lens driving device 10 may comprise an OIS-y magnet 710. The OIS-y drive unit 700 may comprise an OIS-y magnet 710. The OIS-y magnet 710 may be an ‘OIS-y magnet’. The OIS-y magnet 710 may be a permanent magnet. The OIS-y magnet 520 may be disposed in the OIS moving unit. The OIS-y magnet 710 may be spaced apart from the OIS-x magnet 610. The OIS-y magnet 710 may be spaced apart from the AF magnet 510. The OIS-y magnet 710 may be disposed in the OIS-y moving unit 400. The OIS-y magnet 710 can be disposed in the OIS-y carrier 410. The OIS-y magnet 710 can be disposed on an outer side surface of the OIS-y carrier 410. The OIS-y magnet 710 can be fixed to the OIS-y carrier 410. The OIS-y magnet 710 can be coupled to the OIS-y carrier 410. The OIS-y magnet 710 can be attached to the OIS-y carrier 410 with an adhesive. The OIS-y magnet 710 can be disposed inside the cover 120. The OIS-y magnet 710 can interact with the OIS-y coil 720. The OIS-y magnet 710 can electromagnetically interact with the OIS-y coil 720. The OIS-y magnet 710 can be disposed at a position corresponding to the OIS-y coil 720. The OIS-y magnet 710 and the OIS-y coil 720 can face each other. The OIS-y magnet 710 can face the OIS-y coil 720. The OIS-y magnet 710 can be overlapped with the OIS-y coil 720 in a direction perpendicular to the optical axis. The OIS-y magnet 710 can be overlapped with the OIS-y coil 720 in an x-axis direction. The OIS-y magnet 710 can move in a y-axis direction.

The OIS-y magnet 710 may be a four-pole magnet. The OIS-y magnet 710 may comprise a four-pole magnetizing magnet. The OIS-y magnet 710 may comprise a first magnet portion comprising an N pole and an S pole, and a second magnet portion comprising an N pole and an S pole. The first magnet portion and the second magnet portion may be disposed in a horizontal direction. The first magnet portion and the second magnet portion may be spaced apart in the horizontal direction. A neutral portion may be disposed between the first magnet portion and the second magnet portion.

The lens driving device 10 may comprise an OIS-y coil 720. The OIS-y drive unit 700 may comprise an OIS-y coil 720. The OIS-y coil 720 may interact with the OIS-y magnet 710. The OIS-y coil 720 may be disposed at an opposite side of the AF coil 520 with respect to the optical axis. The OIS-y coil 720 may move the OIS-y magnet 710 in a y-axis direction perpendicular to both the optical axis and the x-axis. The OIS-y coil 720 may move the OIS-y magnet 710 in a y-axis direction through interaction with the OIS-y magnet 710. The OIS-y coil 720 and the OIS-y magnet 710 may face each other. The OIS-y coil 720 may face the OIS-y magnet 710. The OIS-y coil 720 may be disposed at a position corresponding to the OIS-y magnet 710. The OIS-y coil 720 may be overlapped with the OIS-y magnet 710 in a direction perpendicular to the optical axis. The OIS-y coil 720 may be overlapped with the OIS-y magnet 710 in an x-axis direction. The OIS-y coil 720 may be disposed in the inner substrate 720. The OIS-y coil 720 may be disposed in the inner substrate 720. The OIS-y coil 720 may be disposed in the AF carrier 200. The OIS-y coil 720 can be disposed in the AF carrier 210 through the inner substrate 720. The OIS-y coil 720 can move integrally with the AF moving unit 200.

In the present embodiment, the OIS-y coil 720 can move together with the AF moving unit 200. The OIS-y coil 720 can move in an optical axis direction together with the AF moving unit 200. During the AF driving process, the OIS-y coil 720 can move in an optical axis direction together with the AF moving unit 200. The OIS-y coil 720 can be disposed in the AF moving unit 200. The OIS-y coil 720 can be fixed to the AF moving unit 200. The OIS-y coil 720 can be coupled to the AF moving unit 200.

The lens driving device 10 may comprise an OIS-y sensor 730. The OIS-y drive unit 700 may comprise an OIS-y sensor 730. The OIS-y sensor 730 may be disposed in an inner substrate 720. The OIS-y sensor 730 may be disposed in an AF carrier 210. The OIS-y sensor 730 may be disposed in an OIS moving unit 200. The OIS-y sensor 730 may comprise a Hall sensor. The OIS-y sensor 730 may detect an OIS-y magnet 710. The OIS-y sensor 730 may detect a magnetic force of the OIS-y magnet 710. The OIS-y sensor 730 may be disposed at a lower side of the OIS-y magnet 620. The OIS-y sensor 730 may be overlapped with the OIS-y magnet 620 in an optical axis direction. In a modified embodiment, the OIS-y sensor 730 may be disposed inside the OIS-y coil 720. At this time, the OIS-y sensor 730 may be overlapped with the OIS-y coil 720 in an optical axis direction. The OIS-y sensor 730 may face the OIS-y magnet 710. The OIS-y sensor 730 may be disposed at a position corresponding to the OIS-y magnet 710. The OIS-y sensor 730 may detect the movement of the OIS-y magnet 710. The amount of movement or position of the OIS-y magnet 710 detected by the OIS-y sensor 730 may be used for feedback of the handshake correction drive in a y-axis direction.

The lens driving device 10 may comprise an OIS-y yoke 740. The OIS-y yoke 740 may be disposed in the OIS-y magnet 710. The OIS-y yoke 740 may be disposed between the OIS-y magnet 710 and the OIS-y carrier 410. The OIS-y yoke 740 may prevent magnetic flux leakage of the OIS-y magnet 710 and enhance interaction with the OIS-y coil 720.

When viewed from above, the AF magnet 510, the AF coil 520, the OIS-y magnet 710, and the OIS-y coil 720 can be disposed in order on a virtual straight line. When viewed from above, the AF magnet 510, the AF coil 520, the OIS-y magnet 710, and the OIS-y coil 720 can be disposed in order on a virtual straight line. When viewed from above, the AF magnet 510, the AF coil 520, the OIS-y magnet 710, and the OIS-y coil 720 can be disposed in order. When viewed from above, the AF magnet 510, the AF coil 520, the OIS-y magnet 710, and the OIS-y coil 720 can be disposed in order in an x-axis direction. When viewed from above, the AF magnet 510, the AF coil 520, the OIS-y magnet 710, and the OIS-y coil 720 can be overlapped in an x-axis direction.

When viewed from above, the AF magnet 510, the AF coil 520, the OIS-y magnet 710, and the OIS-y coil 720 may be sequentially disposed on a first imaginary straight line parallel to an x-axis direction. When viewed from above, the AF magnet 510, the AF coil 520, the OIS-y magnet 710, and the OIS-y coil 720 may be sequentially disposed on a first imaginary straight line parallel to an x-axis direction. When viewed from above, the AF magnet 510, the AF coil 520, the OIS-y magnet 710, and the OIS-y coil 720 may be sequentially superimposed on a first imaginary straight line parallel to an x-axis direction.

When viewed from above, the AF magnet 510, the AF coil 520, the magnet 910, and the yoke 920 may be sequentially disposed on a virtual second straight line parallel to an x-axis direction. When viewed from above, the AF magnet 510, the AF coil 520, the magnet 910, and the yoke 920 may be sequentially disposed on a virtual second straight line parallel to an x-axis direction. When viewed from above, the AF magnet 510, the AF coil 520, the magnet 910, and the yoke 920 may be sequentially overlapped on a virtual second straight line parallel to an x-axis direction.

In the present embodiment, the cover 120 may comprise a first side plate and a second side plate being disposed opposite to each other, and a third side plate and a fourth side plate being disposed opposite to each other. An AF drive unit 500 may be disposed at a position corresponding to the first side plate of the cover 120, an OIS-x drive unit 600 may be disposed at a position corresponding to the third side plate of the cover 120, and an OIS-y drive unit 700 may be disposed at a position corresponding to the second side plate of the cover 120.

The lens driving device 10 may comprise a guide member. The guide member may comprise a ball. The guide member may comprise a pin. The guide member may comprise a cylindrical member. The guide member may guide movement of the moving unit against the fixed unit 100 in a specific direction.

The lens driving device 10 may comprise an AF guide ball 810. The AF guide ball 810 may guide movement of the AF carrier 210 against the base 110 in an optical axis direction. The AF guide ball 810 may be disposed between the fixed unit 100 and the AF moving unit 200. The AF guide ball 810 may be disposed between the base 110 and the AF carrier 210. The AF guide ball 810 may be disposed between the base 110 and the AF carrier 210 in an x direction. The AF guide ball 810 may comprise a ball being disposed in a groove 113 of the base 110. The AF guide ball 810 may comprise a ball being disposed in a metal member 940. The AF guide ball 810 may be disposed in a groove 211 of the AF carrier 210. The AF guide ball 810 may have a spherical shape. The AF guide ball 810 may be formed of metal. Grease may be applied to the surface of the AF guide ball 810.

The AF guide ball 810 may be disposed at the first corner of the base 110. The AF guide ball 810 may be disposed at the second corner opposite the first corner of the base 110. The AF guide ball 810 may be disposed at a first corner and a second corner of the base 110. The AF guide ball 810 may be disposed in two sets at each of the first corner and the second corner of the base 110. At this time, one set may comprise four balls. The two sets may be disposed at an opposite side of the pillar portion of the AF carrier 210.

The AF guide ball 810 may comprise a plurality of balls. The AF guide ball 810 may comprise eight balls. The eight balls may be disposed in two sets of four balls each on one side. The four balls may have different sizes. Two large balls may be disposed at an upper end and a lower end, and two small balls may be disposed therebetween. Four AF guide balls 810 may be disposed at one side of the AF magnet 510, and the remaining four AF guide balls 810 may be disposed at the other side of the AF magnet 510.

Two of the four sets of AF guide balls 810 can be in direct contact with the base 110 and the AF carrier 210. The remaining two of the four sets of AF guide balls 810 can be in direct contact with the AF carrier 210 and the metal member 940.

The lens driving device 10 may comprise an OIS-x guide ball 820. The OIS-x guide ball 820 may guide movement of the OIS-x carrier 310 against the AF carrier 210 in an x-axis direction. The OIS-x guide ball 820 may be disposed between the AF moving unit 200 and the OIS-x moving unit 300. The OIS-x guide ball 820 may be disposed between the AF carrier 210 and the OIS-x carrier 310. The OIS-x guide ball 820 may be disposed between the AF carrier 210 and the OIS-x carrier 310 in a y-axis direction. The entire area from the lower end to the upper end of the OIS-x guide ball 820 may be overlapped with both the AF carrier 210 and the OIS-x carrier 310 in a y-axis direction. The entire area of the OIS-x guide ball 820 may be overlapped with the AF carrier 210 and the OIS-x carrier 310 in a y-axis direction. The OIS-x guide ball 820 may be disposed between the inner side surface of the AF carrier 210 and the outer side surface of the OIS-x carrier 310. When viewed from the outside of the OIS-x carrier 310, the OIS-x guide ball 820 may be overlapped with the OIS-x magnet 610 in a horizontal direction.

The OIS-x guide ball 820 may be disposed in the groove 212 of the AF carrier 210. The OIS-x guide ball 820 may be disposed in the groove 311 of the OIS-x carrier 310. The OIS-x guide ball 820 may comprise a first ball being in contact with the AF carrier 210 and the OIS-x carrier 310 at four points, and a second ball being in contact with the AF carrier 210 and the OIS-x carrier 310 at three points. The OIS-x guide ball 820 may have a spherical shape. The OIS-x guide ball 820 may be formed of metal. Grease may be applied to the surface of the OIS-x guide ball 820.

The OIS-x guide ball 820 may comprise a plurality of balls. The OIS-x guide ball 820 may comprise four balls. Two OIS-x guide balls 820 may be disposed at one side of the OIS-x magnet 610, and the remaining two OIS-x guide balls 820 may be disposed at the other side of the OIS-x magnet 610.

The lens driving device 10 may comprise an OIS-y guide ball 830. The OIS-y guide ball 830 may guide the movement of the OIS-y carrier 410 against the OIS-x carrier 310 in a y-axis direction. The OIS-y guide ball 830 may be extension portion between the OIS-x moving unit 300 and the OIS-y moving unit 400. The OIS-y guide ball 830 may be extension portion between the OIS-x carrier 310 and the OIS-y carrier 410. The OIS-y guide ball 830 may be extension portion between the OIS-x carrier 310 and the OIS-y carrier 410 in an x-axis direction. The entire area from the lower end to the upper end of the OIS-y guide ball 830 can be overlapped with both the OIS-x carrier 310 and the OIS-y carrier 410 in an x-axis direction. The OIS-y guide ball 830 can be disposed between an inner side surface of the OIS-x carrier 310 and an outer side surface of the OIS-y carrier 410. When viewed from the outside of the OIS-y carrier 410, the OIS-y guide ball 830 can be overlapped with the OIS-y magnet 710 in a horizontal direction. Here, the horizontal direction can be any direction perpendicular to the optical axis.

A portion of the OIS-y guide ball 830 may be overlapped with the OIS-x carrier 310 in a y-axis direction. The other portion of the OIS-y guide ball 830 may be overlapped with the OIS-y carrier 410 in a y-axis direction.

The OIS-y guide ball 830 may be disposed in the groove 312 of the OIS-x carrier 310. The OIS-y guide ball 830 may be disposed in the groove 411 of the OIS-y carrier 410. The OIS-y guide ball 830 may comprise a first ball being in contact with the OIS-x carrier 310 and the OIS-y carrier 410 at four points, and a second ball being in contact with the OIS-x carrier 310 and the OIS-y carrier 410 at three points. The OIS-y guide ball 830 may have a spherical shape. The OIS-y guide ball 830 may be formed of metal. Grease may be applied to the surface of the OIS-y guide ball 830.

The OIS-y guide ball 830 may comprise a plurality of balls. The OIS-y guide ball 830 may comprise four balls. Two OIS-y guide balls 830 may be disposed at one side of the OIS-y magnet 710, and the remaining two OIS-y guide balls 830 may be disposed at the other side of the OIS-y magnet 710.

The lens driving device 10 may comprise substrates 860 and 870. The substrates 860 and 870 may comprise a flexible printed circuit board (FPCB). The substrates 860 and 870 may be electrically connected to the coils 520, 620, and 720. The substrates 860 and 870 may be electrically connected to the sensors 530, 6530, and 730.

The lens driving device 10 may comprise an outer substrate 860. The outer substrate 860 may be disposed in the base 110. The outer substrate 860 may be electrically connected to the coils 520, 620, and 720. The outer substrate 860 may be electrically connected to the sensors 530, 630, and 730. The outer substrate 860 may connect the AF carrier 210 to the base 110. The outer substrate 860 may elastically connect the AF carrier 210 to the base 110. The outer substrate 860 may movably support the AF carrier 210 against the base 110. The outer substrate 860 may guide the AF carrier 210 to move in an optical axis direction against the base 110. The outer substrate 860 may comprise a flexible substrate. The outer substrate 860 may comprise a flexible printed circuit board (FPCB). The outer substrate 860 may comprise an elastic portion. The outer substrate 860 may comprise a member having elasticity. The outer substrate 860 may comprise an elastic member. The outer substrate 860 may be disposed in the fixed unit 100. The outer substrate 860 may comprise an outer portion 861 being disposed in the fixed unit 100, and a connection portion 862 being extended from the outer portion 861 and coupled to the inner substrate 870.

The outer substrate 860 may comprise an outer portion 861. The outer portion 861 may be disposed on the base 110. The outer portion 861 may be formed to surround a side surface of the base 110. The outer portion 861 may be disposed on three side surfaces of the base 110. The outer portion 861 may comprise two terminal portions. The two terminal portions may be disposed opposite to each other with respect to an optical axis. The terminal portion may comprise the terminal 862-1.

The outer substrate 860 may comprise a terminal 861-1. The outer portion 861 of the outer substrate 860 may comprise a terminal 861-1. The terminal 861-1 may be electrically connected to the terminal 862-1. The terminal 861-1 may be disposed at a lower end of the base 110. The terminal 861-1 may be coupled to the printed circuit board 50. The terminal 861-1 may be coupled to a terminal of the printed circuit board 50 through a solder. The terminal 861-1 may be coupled to a terminal of the printed circuit board 50 through a conductive member. The terminal 861-1 may be connected to a terminal of the printed circuit board 50. The terminal 861-1 may be electrically connected to a terminal of the printed circuit board 50.

The outer substrate 860 may comprise a connection portion 862. The connection portion 862 may be an extension portion. The connection portion 862 may be a leg portion. The connection portion 862 may extend from the outer part 861. At least a portion of the connection portion 862 may move together with the AF carrier 210. The extension portion may be extended from the outer portion 861. At least a portion of the extension portion may move together with the AF carrier 210. At least a part of the connection portion 862 may be disposed perpendicular to the optical axis direction. As a modified embodiment, at least a portion of the connection portion 862 may be disposed in parallel with an optical axis direction. The connection portion 862 of the outer substrate 860 may be movably coupled to the inner substrate 870 so that the inner substrate 870 can be moved in an optical axis direction.

The connection portion 862 may comprise a plurality of connection portions. The connection portion 862 may comprise a first connection portion and a second connection portion. The second connection portion may be positioned below the first connection portion.

The outer substrate 860 may comprise a terminal 862-1. The connection portion 862 of the outer substrate 860 may comprise a terminal 862-1. The terminal 862-1 may be coupled to a terminal 871-1 of the inner substrate 870. The terminal 862-1 of the outer substrate 860 may be coupled to the terminal 871-1 of the inner substrate 870 through a solder. The terminal 862-1 of the outer substrate 860 may be coupled to the terminal 871-1 of the inner substrate 870 through a conductive member. The terminal 862-1 of the outer substrate 860 may be connected to the terminal 871-1 of the inner substrate 870. The terminal 862-1 of the outer substrate 860 can be electrically connected to the terminal 871-1 of the inner substrate 870.

Hereinafter, any one of a ‘terminal 861-1’ and a ‘terminal 862-1’ of the outer substrate 860 is referred to as a ‘first terminal’ and the other may be referred to as a ‘second terminal’.

The lens driving device 10 may comprise an inner substrate 870. The inner substrate 870 may be electrically connected to coils 520, 620, and 720. The inner substrate 870 may be electrically connected to sensors 530, 630, and 730. The inner substrate 870 may be disposed in the AF moving unit 200. The inner substrate 870 may be disposed in the AF carrier 210. The inner substrate 870 may be fixed to the AF carrier 210. The inner substrate 870 may be coupled to the AF carrier 210. The inner substrate 870 may be attached to the AF carrier 210 with an adhesive. The inner substrate 870 may comprise a flexible substrate. The inner substrate 870 may comprise a flexible printed circuit board (FPCB). The inner substrate 870 may comprise an elastic portion. The inner substrate 870 may comprise an elastic member.

The inner substrate 870 may comprise a side plate portion 871. The side plate portion 871 may be extension portion on a side surface of the AF carrier 210. The side plate portion 871 may be extension portion on an outer side surface of the AF carrier 210. In another embodiment, the side plate portion 871 may be extension portion on an inner surface of the AF carrier 210. The side plate portion 871 of the inner substrate 870 may comprise a plurality of portions. The side plate portion 871 may comprise first to fourth portions.

The inner substrate 870 may comprise a first portion. The first portion may be extension portion in the AF carrier 210. The first portion may be extension portion on a first side of the AF carrier 210. The AF coil 520 may be extension portion in a first portion of the inner substrate 870. The AF sensor 530 may be extension portion on a first portion of the inner substrate 870. The AF yoke 540 may be extension portion on the first portion of the inner substrate 870.

The inner substrate 870 may comprise a second portion. The second portion may be disposed at the opposite side of the first portion. The second portion may be disposed in the AF carrier 200. The second portion may be disposed on a second side surface of the AF carrier 200. The OIS-y coil 720 may be disposed in a second portion of the inner substrate 870. The OIS-y sensor 730 may be disposed in a second portion of the inner substrate 870. In more detail, the OIS-y sensor 730 may be disposed on a lower plate portion 872 being bent and disposed at a lower side of the second portion of the inner substrate 870. The OIS-y sensor 730 may be disposed on an upper surface of the lower plate portion 872.

The inner substrate 870 may comprise a third portion. The third portion may be disposed in the AF carrier 200. The third portion may be disposed on a third side surface of the AF carrier 200. The OIS-x coil 620 may be disposed at a third portion of the inner substrate 870. The OIS-x sensor 630 may be disposed in the third portion of the inner substrate 870. In more detail, the OIS-x sensor 630 may be disposed in a lower plate portion 872 being bent and disposed at a lower side of the third portion of the inner substrate 870. The OIS-x sensor 630 may be disposed on an upper surface of the lower plate portion 872.

The inner substrate 870 may comprise a fourth portion. The fourth portion may be disposed at an opposite side of the third portion. The fourth portion may be disposed in the AF carrier 200. The fourth portion may be disposed on a fourth side surface of the AF carrier 200.

The inner substrate 870 may comprise a terminal 871-1. A terminal 871-1 may be disposed in a fourth portion of the inner substrate 870. The terminal 871-1 may be electrically connected to coils 520, 620, and 720. The terminal 871-1 may be electrically connected to sensors 530, 6530, and 730.

The lens driving device may comprise an AF guide ball pressurizing member. The AF guide ball pressurizing member may pressurize the AF guide ball 810. The AF guide ball pressurizing member may keep the AF guide ball 810 in contact with the fixed unit 100 and the AF moving unit 200. The AF guide ball pressurizing member may keep the AF guide ball 810 in contact with the base 110 and the AF carrier 210.

The AF guide ball pressurizing member may comprise a pressurizing member. The pressurizing member may comprise an elastic member 930. The pressurizing member may comprise an attractive member. The pressurizing member may comprise a repulsive member.

The lens driving device may comprise an elastic member 930. The elastic member 930 may be a spring. The elastic member 930 may be a tapered spring. The elastic member 930 may be disposed in the fixed unit 100. The elastic member 930 may press the AF guide ball 810 toward the AF moving unit 200. In a modified embodiment, the elastic member 930 may be disposed in the AF moving unit 200. At this time, the elastic member 930 may press the AF guide ball 810 toward the fixed unit 100. The elastic member 930 may be disposed in one of the fixed unit 100 and the AF moving unit 200 to press the AF guide ball 810 toward the other one of the fixed unit 100 and the AF moving unit 200. The elastic member 930 can pressurize the metal member 940. The elastic member 930 can be disposed between the metal member 940 and the base 110. The elastic member 930 can be disposed between the AF guide ball 810 and the base 110. The elastic member 930 can be disposed in the base 110. The elastic member 930 can pressurize the AF guide ball 810 toward the AF carrier 210. Through this, the AF guide ball 810 can be maintained in contact with the metal member 940 and the AF carrier 210.

The lens driving device may comprise a metal member 940. The metal member 940 may be disposed between the elastic member 930 and the AF guide ball 810. The metal member 940 may press the AF guide ball 810 toward the AF carrier 210 by the elastic member 930.

The lens driving device may comprise a cover 945. The cover 945 may be disposed above the AF guide ball 810. The cover 945 may be overlapped with the AF guide ball 810 in an optical axis direction. The cover 945 may be disposed on the groove 113 of the base 110 and the groove 211 of the AF carrier 210 to prevent the AF guide ball 810 from being separated upward.

In a modified embodiment, the AF ball pressurizing member may comprise a yoke. The yoke may pressurize the first moving unit 200 against the fixed unit 100. The yoke may be in contact with the first moving unit 200 against the fixed unit 100. The yoke may pressurize the first moving unit 200 toward the fixed unit 100. The yoke may be disposed to exert an attractive force on the AF magnet 510. The yoke may be disposed in the inner substrate 870. The yoke may be disposed at a position corresponding to the AF magnet 510. The “yoke” of the modified embodiment may also be referred to as a “first yoke,” a “second yoke,” and the like. The yoke may be understood as a component of the first moving unit 200. Or, the yoke may be coupled to the first moving unit 200 in a separate configuration from the first moving unit 200.

The lens driving device may comprise an OIS-x guide ball pressurizing member. The OIS-x guide ball pressurizing member may pressurize the OIS-x guide ball 820. The OIS-x guide ball pressurizing member may allow the OIS-x guide ball 820 to maintain the state in which the AF moving unit 200 is in contact with the OIS-x moving unit 300. The OIS-x guide ball pressurizing member may allow the OIS-x guide ball 820 to maintain the state in which the AF carrier 210 is in contact with the OIS-x carrier 310.

The lens driving device may comprise a yoke 950. The yoke 950 may be an ‘attractive force yoke’. The yoke 950 may be disposed at a position corresponding to the OIS-x magnet 610. An attractive force may be applied between the yoke 950 and the OIS-x magnet 610. The OIS-x guide ball 820 may maintain the state in which the AF carrier 210 is in contact with the OIS-x carrier 310 by the attractive force between the yoke 950 and the OIS-x magnet 610. The yoke 950 may be disposed in the AF carrier 210. The yoke 950 may move integrally with the AF carrier 210. The yoke 950 may be disposed in the inner substrate 870. The yoke 950 may be disposed on an outer surface of the inner substrate 870. The yoke 950 may be disposed at an opposite side of the OIS-x coil 620 of the inner substrate 870. The yoke 950 may press the OIS-x carrier 310 against the AF carrier 210. The yoke 950 may press the guide frame against the first moving unit 200. The yoke 950 may be in contact with the OIS-x carrier 310 against the AF carrier 210. The yoke 950 may press the OIS-x carrier 310 toward the AF carrier 210. The yoke 950 may be understood as a component of the first moving unit 200. Or, the yoke 950 may be coupled to the first moving unit 200 as a separate configuration from the first moving unit 200.

The lens driving device may comprise an OIS-y guide ball pressurizing member. The OIS-y guide ball pressurizing member may pressurize the OIS-y guide ball 830. The OIS-y guide ball pressurizing member may maintain the OIS-y guide ball 830 in the state in which the OIS-x moving unit 300 is in contact with the OIS-y moving unit 400. The OIS-y guide ball pressurizing member may maintain the OIS-y guide ball 830 in the state in which the OIS-x carrier 310 is in contact with the OIS-y carrier 410.

The lens driving device may comprise a magnet 910. The magnet 910 may be an ‘attractive force magnet’. The magnet 910 may be disposed in the OIS-y moving unit 400. The magnet 910 may be spaced apart from the OIS-y magnet 710. The magnet 910 may not interact with the OIS-y coil 720.

The lens driving device may comprise a yoke 915. The yoke 915 may be disposed at a position corresponding to the magnet 910. The yoke 915 may be disposed in the magnet 910. The yoke 915 may be disposed between the magnet 910 and the OIS-y carrier 410. The yoke 915 may be disposed at an inner surface of the magnet 910. The outer surface of the magnet 910 may face the yoke 920. Through this, the yoke 915 may minimize the leakage flux of the magnet 910 and increase the attractive force between the magnet 910 and the yoke 920.

The lens driving device may comprise a yoke 920. The yoke 920 may be an ‘attractive force yoke’. The yoke 920 may be disposed at a position corresponding to the magnet 910. An attractive force may be applied between the yoke 920 and the magnet 910. The OIS-y guide ball 830 may maintain the state in which the OIS-x carrier 310 is in contact with the OIS-y carrier 410 by the attractive force between the yoke 920 and magnet 910. The yoke 920 may be disposed on the OIS-x carrier 310. The yoke 920 may move integrally with the OIS-x carrier 310. The yoke 920 may be disposed in the OIS-x moving unit 300. The yoke 920 may be disposed in the OIS-x moving unit 300 so that the magnet 910 and the attractive force act thereon. The yoke 920 can press the OIS-y carrier 410 against the OIS-x carrier 310. The yoke 920 can press the bobbin against the guide frame. The yoke 920 can be in contact with the OIS-y carrier 410 against the OIS-x carrier 310. The yoke 920 can press the OIS-y carrier 410 toward the OIS-x carrier 310.

In a modified embodiment, the yoke 920 can bring the OIS-y carrier 410 to be in close contact with the AF carrier 210. The yoke 920 can bring the bobbin to be in close contact with the first moving unit 200. The yoke 920 can bring the OIS-y carrier 410 to be in close contact with the AF carrier 210. The yoke 920 can press the OIS-y carrier 410 toward the AF carrier 210. At this time, the yoke 920 can be understood as a component of the first moving unit 200. Or, the yoke 920 may be coupled to the first moving unit 200 as a separate configuration from the first moving unit 200.

In the present embodiment, when the OIS-x moving unit 300 is moved in an x-axis direction by the OIS-x drive unit 600, the distance between the magnet 910 and the yoke 920 in an x-axis direction may be maintained. At this time, a distance between the OIS-y magnet 710 and the OIS-y coil 720 in an x-axis direction may be varied.

Hereinafter, an auto-focus (AF) driving of the lens driving device according to the present embodiment will be described with reference to the drawings.

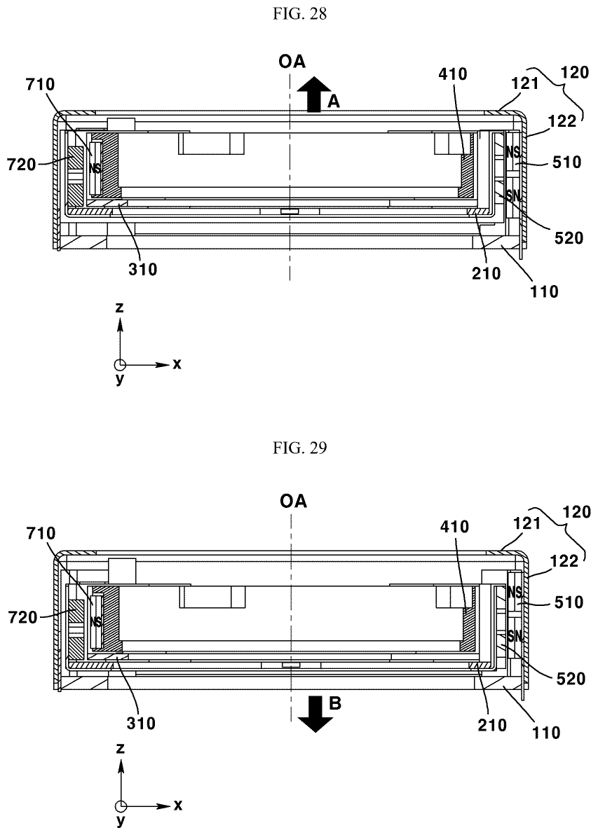

FIGS. 27 to 29 are diagrams for explaining the auto focus driving of a lens driving device according to the present embodiment. FIG. 27 is a cross-sectional view illustrating the appearance of a moving unit in an initial state where no current is applied to the AF coil; FIG. 28 is a cross-sectional view illustrating the appearance where a moving unit moves upward in an optical axis direction when a forward current is applied to an AF coil; and FIG. 29 is a cross-sectional view illustrating the appearance where a moving unit moves downward in an optical axis direction when a reverse current is applied to an AF coil.

As illustrated in FIG. 27, at an initial position where no current is applied to the AF coil 520, the moving unit may be disposed at a position being spaced apart from both the upper plate 121 and the base 110 of the cover 120. At this time, the moving unit may be the AF moving unit 200. In addition, the moving unit may comprise an AF moving unit 200 and an OIS moving unit.

When a forward current is applied to the AF coil 520, the AF coil 520 may move upward in an optical axis direction by an electromagnetic interaction between the AF coil 520 and the AF magnet 510 (see A of FIG. 28). At this time, the AF carrier 210 may move upward in an optical axis direction together with the AF coil 520. Furthermore, the OIS-x carrier 310, the OIS-y carrier 410, and the lens may move upward in an optical axis direction together with the AF carrier 210. Accordingly, the distance between the lens and the image sensor may be changed to adjust a focus of an image being formed on the image sensor through the lens.

When a reverse current is applied to the AF coil 520, the AF coil 520 may move to a lower side of the optical axis direction by an electromagnetic interaction between the AF coil 520 and the AF magnet 510 (see B of FIG. 29). At this time, the AF carrier 210 may move downward in an optical axis direction together with the AF coil 520. Furthermore, the OIS-x carrier 310, the OIS-y carrier 410, and the lens may move downward in an optical axis direction together with the AF carrier 210. Accordingly, a distance between the lens and the image sensor may be changed to adjust a focus of an image being formed on the image sensor through the lens.

Meanwhile, during the movement of the AF coil 520, the AF sensor 530 moves together with the AF coil 520 and detects the intensity of the magnetic field of the AF magnet 510 to detect the movement amount or position of the lens in an optical axis direction. The movement amount or position of the lens detected by the AF sensor 530 in an optical axis direction may be used for autofocus feedback control.

Hereinafter, the optical image stabilization (OIS) driving of a lens driving device according to the present embodiment will be described with reference to the drawings.

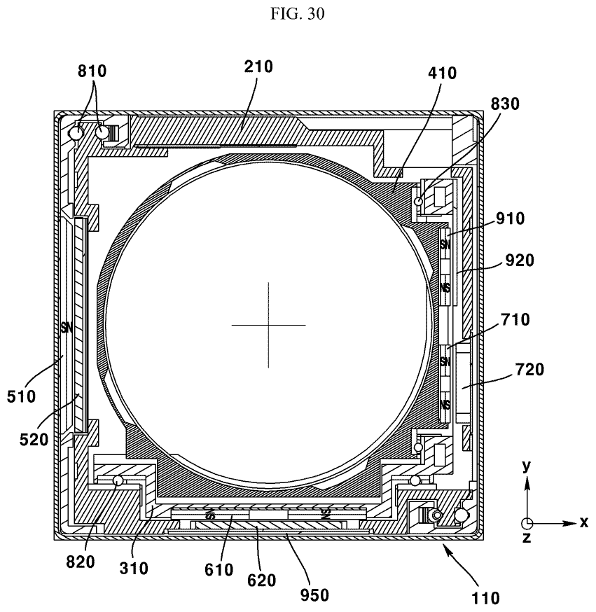

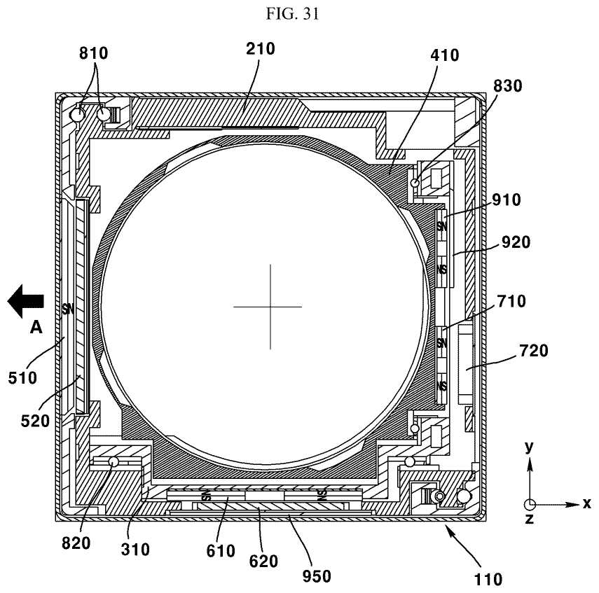

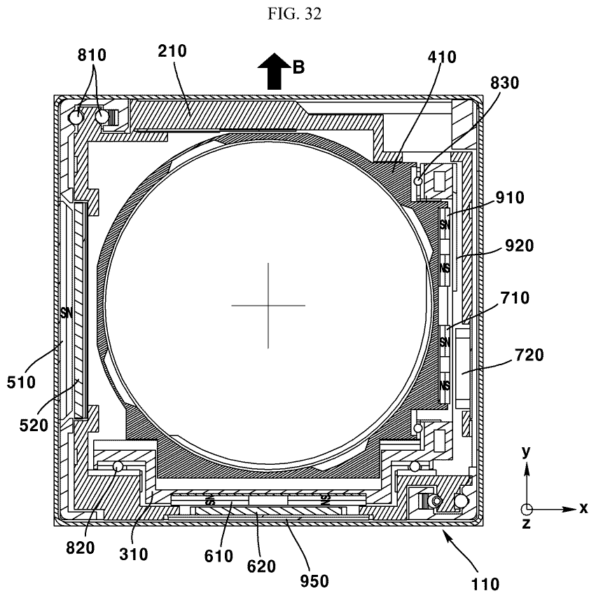

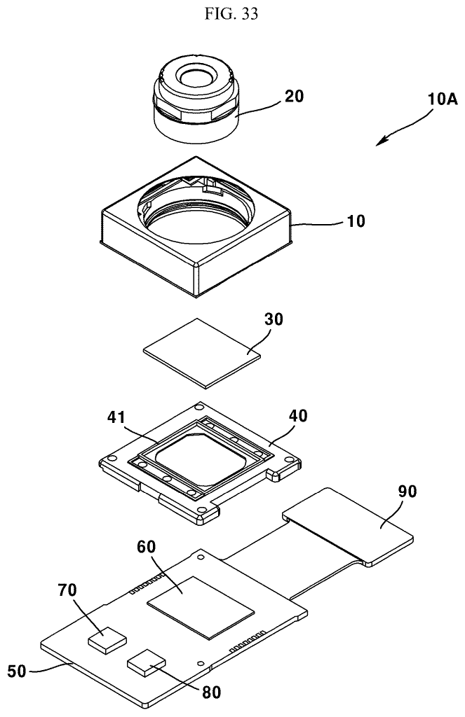

FIGS. 30 to 32 are diagrams for explaining the handshake correction driving of a lens driving device according to the present embodiment. FIG. 30 is a cross-sectional view illustrating the appearance of an OIS moving unit in an initial state in which no current is applied to an OIS-x coil and an OIS-y coil; FIG. 31 is a cross-sectional view illustrating the appearance in which an OIS moving unit moves in an x-axis direction perpendicular to the optical axis when current is applied to the OIS-x coil; and FIG. 32 is a cross-sectional view illustrating the appearance in which the OIS-y moving unit moves in a y-axis direction perpendicular to both the optical axis and the x-axis when current is applied to an OIS-y coil.

As illustrated in FIG. 30, the moving unit may be disposed at an initial position to which current is not applied to the OIS-x coil 620 and the OIS-y coil 720. At this time, the moving unit may be an OIS moving unit.

When a current is applied to the OIS-x coil 620, the OIS-x magnet 610 may move in an x-axis direction perpendicular to the optical axis by an electromagnetic interaction between the OIS-x coil 620 and the OIS-x magnet 610 (see A of FIG. 31). At this time, the OIS-x carrier 310 may move in an x-axis direction together with the OIS-x magnet 610. Furthermore, the OIS-y carrier 410 and the lens may move in an x-axis direction together with the OIS-x carrier 310. In more detail, when a forward current is applied to the OIS-x coil 620, the OIS-x magnet 610, the OIS-x carrier 310, the OIS-y carrier 410, and the lens may move in one direction on the x-axis. Furthermore, when a reverse current is applied to the OIS-x coil 620, the OIS-x magnet 610, the OIS-x carrier 310, the OIS-y carrier 410, and the lens may move in the other direction on an x-axis.

When a current is applied to the OIS-y coil 720, the OIS-y magnet 710 may move in a y-axis direction perpendicular to the optical axis by an electromagnetic interaction between the OIS-y coil 720 and the OIS-y magnet 710 see B of FIG. 32. At this time, the OIS-y carrier 410 may move in a y-axis direction together with the OIS-y magnet 710. Furthermore, the lens may move in a y-axis direction together with the OIS-y carrier 410. More specifically, when a forward current is applied to the OIS-y coil 720, the OIS-y magnet 710, the OIS-y carrier 410, and the lens may move in one direction on a y-axis. In addition, when a reverse current is applied to the OIS-y coil 720, the OIS-y magnet 710, the OIS-y carrier 410, and the lens may move in the other direction on the y-axis.

Meanwhile, the OIS-x sensor 630 may detect the strength of the magnetic field of the OIS-x magnet 610 and detect the movement amount or position of the OIS-x magnet 610. The movement amount or position detected by the OIS-x sensor 630 may be used for handshake correction feedback control in an x-axis direction. The OIS-y sensor 730 may detect the strength of the magnetic field of the OIS-y magnet 710 and detect the movement amount or position of the OIS-y magnet 710. The movement amount or position detected by the OIS-y sensor 730 may be used for handshake correction feedback control in a y-axis direction.

Hereinafter, a camera device according to the present embodiment is described with reference to the drawings.

FIG. 35 is an exploded perspective view of a camera device according to the present embodiment.

The camera device 10A may comprise a camera module.

The camera device 10A may comprise a lens module 20. The lens module 20 may comprise at least one lens. The lens may be disposed at a position corresponding to the image sensor 60. The lens module 20 may comprise a lens and a barrel. The lens module 20 may be coupled to an OIS-y carrier 410 of the lens driving device 10. The lens module 20 may be coupled to the OIS-y carrier 410 by screw-coupling and/or adhesive. The lens module 20 may be moved integrally with the OIS-y carrier 410.

The camera device 10A may comprise a filter 30. The filter 30 may block light of a specific frequency band from passing through the lens module 20 from being incident on the image sensor 60. The filter 30 may be disposed parallel to an x-y plane. The filter 30 may be disposed between the lens module 20 and the image sensor 60. The filter 30 may be disposed in the sensor base 40. In a modified embodiment, the filter 30 may be disposed in the base 110. The filter 30 may comprise an infrared filter. The infrared filter may block light in an infrared region from being incident on the image sensor 60.

The camera device 10A may comprise a sensor base 40. The sensor base 40 may be disposed between the lens driving device 10 and the printed circuit board 50. The sensor base 40 may comprise a protruded portion 41 in which a filter 30 is disposed. An opening may be formed in a portion of the sensor base 40 in which the filter 30 is disposed so that light passing through the filter 30 may be incident on the image sensor 60. An adhesive member may couple or attach the base 110 of the lens driving device 10 to the sensor base 40. The adhesive member may additionally serve to prevent foreign substances from entering the interior of the lens driving device 10. The adhesive member may comprise at least one among an epoxy, a thermosetting adhesive, and an ultraviolet-curable adhesive.

The camera device 10A may comprise a printed circuit board (PCB) 50. The printed circuit board 50 may be a substrate or a circuit board. A lens driving device 10 may be disposed in the printed circuit board 50. A sensor base 40 may be disposed between the printed circuit board 50 and the lens driving device 10. The printed circuit board 50 may be electrically connected to the lens driving device 10. An image sensor 60 may be disposed in the printed circuit board 50. Various circuits, elements, control units, and the like may be provided in the printed circuit board 50 to convert an image formed on the image sensor 60 into an electrical signal and transmit it to an external device.

The camera device 10A may comprise an image sensor 60. The image sensor 60 may be configured such that light passing through a lens and a filter 30 is incident to form an image. The image sensor 60 may be mounted on a printed circuit board 50. The image sensor 60 may be electrically connected to the printed circuit board 50. For example, the image sensor 60 may be coupled to the printed circuit board 50 by surface mounting technology (SMT). As another example, the image sensor 60 may be coupled to the printed circuit board 50 by flip chip technology. The image sensor 60 may be disposed such that its optical axis is aligned with that of the lens. That is, the optical axis of the image sensor 60 and the optical axis of the lens may be aligned. The image sensor 60 can convert light being irradiated to the effective image area of the image sensor 60 into an electrical signal. The image sensor 60 can be any one among a charge coupled device (CCD), a metal oxide semi-conductor (MOS), a CPD, and a CID.

The camera device 10A may comprise a motion sensor 70. The motion sensor 70 may be mounted on a printed circuit board 50. The motion sensor 70 may be electrically connected to a control unit 80 through a circuit pattern provided in the printed circuit board 50. The motion sensor 70 may output rotational velocity information due to the movement of the camera device 10A. The motion sensor 70 may comprise a two-axis or three-axis gyro sensor or an angular velocity sensor.

The camera device 10A may comprise a control unit 80. The control unit 80 may be disposed in a printed circuit board 50. The control unit 80 may be electrically connected to a coil 330 of a lens driving device 10. The control unit 80 may individually control the direction, intensity, and amplitude of current supplied to the coil 330. The control unit 80 may control the lens driving device 10 to perform an auto-focus function and/or a handshake correction function. Furthermore, the control unit 80 may perform auto-focus feedback control and/or handshake correction feedback control for the lens driving device 10.

The camera device 10A may comprise a connector 90. The connector 90 may be electrically connected to a printed circuit board 50. The connector 90 may comprise a port for being electrically connected to an external device.

Hereinafter, an optical device according to the present embodiment is described with reference to drawings.

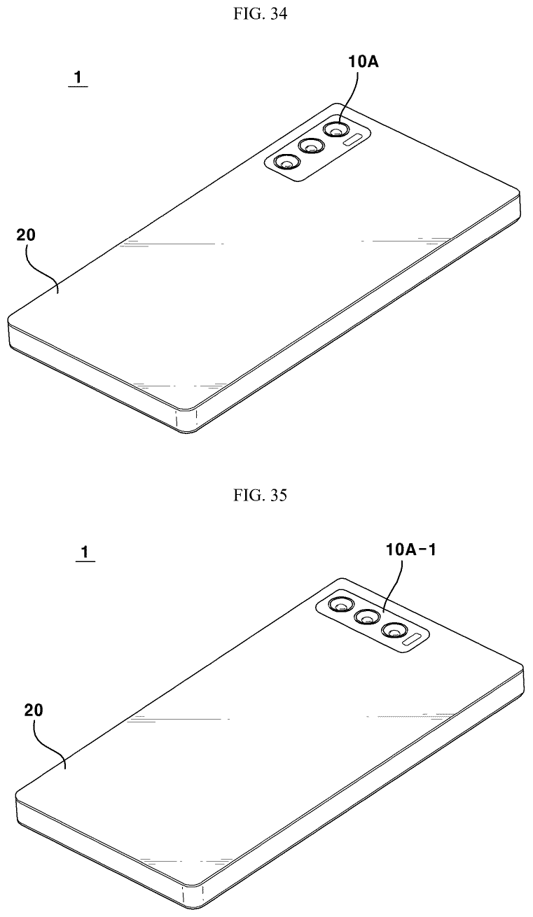

FIG. 34 is a perspective view of an optical device according to the present embodiment; and FIG. 35 is a perspective view of an optical device according to a modified embodiment.

The optical device 1 may comprise any one or more among a mobile phone, a cellular phone, a portable terminal, a mobile terminal, a smart phone, a smart pad, a portable smart device, a digital camera, a laptop computer, a digital broadcasting terminal, a personal digital assistant (PDA), a portable multimedia player (PMP), and a navigation device. The optical device 1 may comprise any device for photographing images or pictures.

The optical device 1 may comprise a main body 20. The optical device 1 may comprise a camera device 10A. The camera device 10A may be disposed in the main body 20. The camera device 10A may photograph a subject. The optical device 1 may comprise a display. The display may be disposed in the main body 20. The display may output one or more of an image and a video photographed by the camera device 10A. The display may be disposed on a first surface of the main body 20. The camera device 10A may be disposed on one or more of the first surface of the main body 20 and the second surface opposite to the first surface. As illustrated in FIG. 34, the camera device 10A may have a triple camera disposed in a vertical direction. As illustrated in FIG. 35, the camera device 10A-1 may have a triple camera disposed in a horizontal direction.

Although the present embodiment of the present invention has been described with reference to the attached drawings, those skilled in the art will understand that the present invention can be implemented in other specific forms without changing the technical idea or essential characteristics thereof. Therefore, it should be understood that the embodiments described above are exemplary in all respects and not restrictive.

1. A lens driving device comprising:
a fixed unit;
a first moving unit disposed on the fixed unit;
a second moving unit disposed in the first moving unit and comprising a bobbin and a guide frame;
a first drive unit configured to move the first moving unit in an optical axis direction;
a second drive unit disposed on the first moving unit and the second moving unit and configured to move the second moving unit in an x-axis; and
a third drive unit configured to move the bobbin in a y-axis.

2. The lens driving device of claim 1, wherein the first moving unit brings the bobbin in close contact with the guide frame.

3. The lens driving device of claim 1, wherein the first moving unit comprises a yoke configured to bring the bobbin in close contact with the guide frame.

4. The lens driving device of claim 1, wherein the first moving unit comprises a first yoke configured to bring the first moving unit in close contact with the fixed unit and a second yoke configured to bring the guide frame in close contact with the first moving unit.

5. The lens driving device of claim 4, comprising a third yoke configured to bring the bobbin in close contact with the guide frame.

6. The lens driving device of claim 5, wherein the first moving unit comprises a housing, and the first to third yokes are coupled with the housing.

7. The lens driving device of claim 1, wherein the third drive unit comprises a first magnet disposed on the bobbin and a first coil configured to interact with the first magnet, and
wherein the first coil is configured to move together with the first moving unit.

8. The lens driving device of claim 7, wherein the second drive unit comprises a second magnet disposed on the guide frame and a second coil configured to interact with the second magnet, and
wherein the second coil is configured to move together with the first moving unit.

9. The lens driving device of claim 8, wherein the first drive unit comprises a third magnet disposed on the fixed unit and a third coil configured to interact with the third magnet, and
wherein the third coil is configured to move together with the first moving unit.

10. A lens driving device comprising:
a base;
a housing disposed on the base;
a guide frame disposed in the housing;
a bobbin disposed in the guide frame;
a first ball disposed between the base and the housing;
a second ball disposed between one side surface of the guide frame and a side surface of the housing; and
a third ball disposed between a side surface of the bobbin and the other side surface of the guide frame.

11. The lens driving device of claim 9, comprising:
a fourth magnet disposed on the bobbin; and
a yoke disposed on the second moving unit so as to exert an attractive force on the fourth magnet.

12. The lens driving device of claim 11, wherein, when the second moving unit moves along the x-axis by the second drive unit, a distance between the fourth magnet and the yoke along the x-axis is maintained, and a distance between the first magnet and the first coil along the x-axis is changed.

13. The lens driving device of claim 11, wherein the fourth magnet is spaced apart from the first magnet, and
wherein the fourth magnet does not face the first coil.

14. The lens driving device of claim 11, wherein each of the first magnet, the second magnet, and the fourth magnet comprises a first magnet portion comprising an N pole and an S pole, a second magnet portion comprising an S pole and an N pole, and a neutral portion disposed between the first magnet portion and the second magnet portion.

15. The lens driving device of claim 11, wherein, when viewed from above, the third magnet, the third coil, the first magnet, and the first coil are disposed in sequence on a first imaginary straight line parallel to the x-axis.

16. The lens driving device of claim 15, wherein, when viewed from above, the third magnet, the third coil, the fourth magnet, and the yoke are disposed in sequence on a second imaginary straight line parallel to the x-axis.

17. A camera device comprising:
a printed circuit board;
an image sensor disposed on the printed circuit board;
the lens driving device of claim 1 disposed on the printed circuit board; and
a lens coupled with the lens driving device.

18. An optical device comprising:
a main body;
the camera device of claim 17 disposed on the main body; and
a display disposed on the main body and configured to output at least one of an image and a video photographed by the camera device.

19. A lens driving device comprising:
a fixed unit;
a first moving unit disposed on the fixed unit;
a second moving unit disposed in the first moving unit and comprising a bobbin and a guide frame;
a first drive unit configured to move the first moving unit in an optical axis direction;
a second drive unit configured to move the second moving unit in a direction perpendicular to the optical axis direction;
a first support member disposed between the first moving unit and the fixed unit;
a second support member disposed between the first moving unit and a side surface of the second moving unit; and
a third support member disposed between a side surface of the bobbin and a side surface of the guide frame.

20. The lens driving device of claim 19, comprising:
a first driving unit configured to move the guide frame in a first direction perpendicular to the optical axis direction; and
a second driving unit configured to move the bobbin in a second direction perpendicular to the optical axis direction and the first direction.
